(19) United States
(12) Patent Application Publication
(10) Pub. No.: US 2025/0272472 A1
(43) Pub. Date: Aug. 28, 2025

(54) DYNAMIC VISUAL PRESENTATION SYSTEM FOR TRACKING CONTENT AGE AND AUTHORSHIP IN DIGITAL DOCUMENTS

(71) Applicant: Liane Ma, Cary, NC (US)

(72) Inventor: Liane Ma, Cary, NC (US)

(21) Appl. No.: 19/063,194

(22) Filed: Feb. 25, 2025

Related U.S. Application Data
(60) Provisional application No. 63/557,595, filed on Feb. 25, 2024.

(51) Int. Cl. G06F 40/109; G06F 30/20

(52) U.S. Cl. CPC G06F 40/109; G06F 30/20

(57) ABSTRACT

A method for presentation of content in a digital document includes automatically altering the presentation based on spatiotemporal parameters of the content inputted by one or more users.

### CROSS-REFERENCE TO RELATED APPLICATION

The present disclosure claims priority to U.S. Provisional Patent Application No. 63/557,595 filed Feb. 25, 2024, the disclosure of which is hereby incorporated by reference in its entirety.

### BACKGROUND

Simulations typically refer to computer-based modeling of physical systems. Data input, organization, analysis, and presentation are often involved.

### SUMMARY

In an aspect, a method for presentation of content in a digital document is provided, including: automatically altering the presentation based on spatiotemporal parameters of the content inputted by one or more users.

In some embodiments, the digital document is a spread sheet or a word processing document.

In some embodiments, the presentation is a visual presentation.

In some embodiments, the visual presentation includes at least one of colors, shades, or fonts.

In some embodiments, the spatiotemporal parameters comprise a time of input of the content.

In some embodiments, the colors gradually change over time elapsed since the time of input of the content.

In some embodiments, the colors change from red to orange, to green, and then to black over the time elapsed.

In some embodiments, the fonts are normal and upright at the time of input of the content.

In some embodiments, the fonts are automatically rotated sideways over the time elapsed as if falling asleep.

In some embodiments, the shades gradually fade over time elapsed since the time of input of the content.

In some embodiments, the shades gradually become lighter over the time elapsed.

In some embodiments, the presentation is an audio presentation.

In some embodiments, the audio presentation turns into a sleepy tone over the elapsed time.

In some embodiments, the presentation includes texts, wherein the texts are presented in an initial font style and color selected by a user or by system default at the time of input, and wherein the texts gradually change in fonts and become more slanted, and gradually fade in colors and/or hues with the time elapsed to indicate an age of the content.

In some embodiments, the spatiotemporal parameters comprise a location and/or a user identification.

In some embodiments, the digital document is a collaborative document, wherein the presentation comprises texts, and wherein the texts are presented in fonts and colors automatically determined based on the location and/or the user identification to thereby differentiate inputs from different users and/or locations.

In some embodiments, the fonts and colors further gradually change to indicate an age of the content.

In some embodiments, the method further includes waking up the content by a clicking or audio command.

In some embodiments, the waking up includes restoring the presentation toward the initial presentation.

In another aspect, a simulation-based optimization method is provided, including: simulating a process for drafting a patent application, including: searching uncopyrighted literature for references related to an invention disclosure or a draft claim; rewriting content from the references to be embodiments or variations of the invention disclosure or the draft claim; iterating said searching the uncopyrighted literature and said rewriting the content to expand the rewritten content; generating a plurality of draft patent applications based on the rewritten content from a plurality of subsets of the references; selecting an optimal one of the plurality of draft patent applications to be the patent application based on at least one of a patent examination simulation or a patent litigation simulation; wherein the patent examination simulation includes: searching prior art related to the plurality of draft patent applications; and selecting one or more of the draft patent applications based on simulated allowance probabilities based on the searched prior art; and wherein the patent litigation simulation includes: searching case laws related to the one or more of the plurality of draft patent applications; searching product related to the one or more of the plurality of draft patent applications; simulating infringement probabilities based on the searched product; simulating invalidity proceedings and infringement findings in a number of court systems; and selecting an optimized patent application based on likelihood of winning the invalidity proceedings and infringement findings.

### BRIEF DESCRIPTION OF THE DRAWINGS

To elucidate the technical solutions presented in the embodiments of the present disclosure, a brief introduction to the accompanying drawings is provided. The drawings included in the following description represent some example embodiments of the present disclosure.

FIG. 1 is a block diagram illustrating a spatiotemporal parameter-based presentation for text transformation, depicting progressive changes in font style, color fading, and color transitions over time.

FIG. 2 is a flowchart illustrating a method for presentation alteration based on spatiotemporal parameters.

FIG. 3 illustrates the application of spatiotemporal parameters through the progressive modification of text presentation within a spreadsheet application. The figure shows changes such as text slanting to visually represent the age of the content.

FIG. 4 illustrates the application of spatiotemporal parameters through the progressive modification of text presentation within a spreadsheet application. The figure showcases changes such as text color fading and a combination of fading with slanting to visually represent the age of the content.

FIG. 5 illustrates a collaborative document editing system, with multiple client and network-based content management system architecture. The figure depicts multiple computing devices, including laptops, a desktop computer, and a tablet, interconnected via a network. The system integrates a content management system, a synchronization module, and an authentication module, along with cloud storage, to facilitate data access, synchronization, and secure authentication across devices.

FIG. 6 illustrates a text formatting method that applies different font style to differentiate content created or edited by different clients, according to some embodiments.

FIG. 7 illustrates a text formatting method that applies different font color or font background color or transparency to differentiate content created or edited by different clients, according to one embodiment.

FIG. 8 illustrates a method for dynamically altering the presentation of content in a digital document representing the freshness of the text.

The accompanying drawings serve to depict the principles and operations of the embodiments, offering a visual representation to support understanding. The figures are not to be construed as limiting the scope of the application; rather, they are provided as examples to aid in comprehension. It is intended that all modifications, equivalents, and alternatives that fall within the spirit and scope of the present application, as defined by the appended claims, are encompassed.

### DETAILED DESCRIPTION

In an aspect, a method for presentation of content in a digital document is provided, including: automatically altering the presentation based on spatiotemporal parameters of the content inputted by one or more users.

The present disclosure pertains to the field of digital document management, specifically involving the dynamic presentation of text in documents such as spreadsheets and word-processing files. This area of technology is important for enhancing user interaction and collaboration in digital environments, where users often need to track changes, manage tasks, and identify content authorship over time.

The inventor of the present disclosure has recognized that, despite of advancements in digital document management, there are persistent challenges in effectively managing and visualizing the temporal aspects of document content. Users frequently encounter difficulties in remembering when specific entries were made, which can lead to missed deadlines or overlooked tasks. Additionally, distinguishing between new and old content in collaborative documents remains a cumbersome task, often requiring manual tracking or reliance on external reminders. Existing solutions, such as those described in prior patents, focus on content reflow, comment navigation, and collaborative editing, but do not adequately address the need for intuitive visual cues that reflect the age of document entries.

Various embodiments of the present disclosure provide improved systems that provide intuitive, time-based visual transformations of text attributes to indicate content age and authorship. By dynamically altering text presentation based on the elapsed time since entry, embodiments of the present disclosure provide the ability to visually track document changes over time.

In the novel approach by implementing a dynamic visual system that gradually changes text attributes such as font style, color, and orientation over time, the methods according to various embodiments of the present disclosure not only enhance user awareness of content age, but also facilitate better task management and collaboration by providing clear, visual differentiation of content based on its temporal context.

In a method for the presentation of content in digital documents according to embodiments of the present disclosure, the presentation is automatically altered based on spatiotemporal parameters of the content inputted by one or more users. This method applies to digital documents such as spreadsheets or word-processing documents. The presentation can be visual, comprising elements like colors, shades, or fonts. These visual elements are dynamically adjusted based on the time of input of the content. For instance, colors may gradually change over time, transitioning from red to orange, to green, and then to black, indicating the passage of time since the content was entered. Fonts initially appear normal and upright but are automatically rotated sideways over time, resembling a “falling asleep” effect. Shades also gradually fade, becoming lighter as time elapses. In addition to visual presentations, the method includes audio presentations where the tone becomes sleepier over time.

Some embodiments of the present disclosure can also address collaborative documents by allowing differentiation of inputs from different users and/or locations. Texts are presented in fonts and colors automatically determined based on user identification or location, and these attributes gradually change to indicate the age of the content. This system not only enhances the visual and auditory experience of document management but also aids in task management and deadline reminders, integrating seamlessly with existing document formats and ensuring accessibility for users with visual impairments.

The present disclosure further provides systems and methods for dynamically modifying content presentation in a digital document based on spatial, temporal and author-specific attributes. The disclosed system implements a time-based visual transformation, and/or author-specific visual cues, allowing content presentation attributes, such as font style, color, and orientation, to change over time. Such attributes can help the user to determine the urgency of the task, prioritize their actions, and enhance overall comprehension. By adapting the visual presentation according to the user's context and preferences, the system aims to improve engagement and efficiency in processing information.

In some embodiments, text presentation is dynamically adjusted based on temporal factors. For example, newly entered text may initially be displayed in a bold font with a vibrant color, while older text transitions to a lighter shade or changes in style, such as becoming slightly slant or italicized. When the text reaches a certain age threshold, it may further fade or adopt a more subdued font style to indicate its reduced relevance or priority. The shape of the text could slant more or become more compressed to visually signify its aging status. This transformation provides a visual indication of content recency. This dynamic adjustment helps users quickly identify and prioritize the task while retaining access to older content.

In some other embodiments, the system applies distinct visual styles to differentiate contributions from multiple users. This feature is applicable in collaborative editing environments, where various font styles, colors, or icons can be associated with different authors. The system can allow users to configure these visual distinctions through customizable settings, enabling selection of preferred representations. Such differentiation enhances content clarity and facilitates efficient tracking of modifications within shared documents.

The system can further extend to audio-based content presentation. In certain embodiments, an auditory transformation is applied to audio information to indicate recency. For instance, recently added audio content may be played with a clear and sharp tone, while older audio transitions to a softer, more sleepy and mellow tones. This auditory transformation provides an immediate cue regarding the relative age of information.

The disclosed system and methods are illustrated in the accompanying drawings and described in detail herein. Various embodiments of the system may be implemented independently or in combination, with interchangeable components, features, and functionalities. Although not all variations and implementations are explicitly depicted, the disclosure contemplates combinations of elements from different embodiments as appropriate.

It will be appreciated by those skilled in the art that features, elements, and functionalities of one embodiment may be incorporated into another embodiment unless explicitly stated otherwise. The described embodiments are provided to illustrate the principles of the disclosure and their practical applications, thereby enabling others skilled in the art to implement the described methodologies. Modifications and variations may be made without departing from the scope of the disclosure, which encompasses all such alternatives, modifications, and equivalents.

The disclosed system provides visualized data freshness and authorship indicators within digital content management systems. These features enable efficient tracking of content modifications, particularly in collaborative environments where multiple users contribute to shared documents.

Visualized data freshness allows users to determine the recency and authorship of content through dynamic visual cues. In certain implementations, color coding, font variations, or shading effects denote the relative age of different text segments. This functionality is applicable to environments where data is continuously updated, such as financial market reports, social media analytics, or collaborative workspaces for tasks such as patent drafting.

For example, in a collaborative spreadsheet application, real-time updates may be visually distinguished based on recency. Newly added data can be displayed in a bright color, while older data gradually shifts to a muted tone. This approach enables users to quickly assess the timeliness of content and the user could quickly identify tasks that require immediate attention or updates.

Additionally, text freshness involves prioritizing the display of recent or relevant document sections. In a collaborative editing environment, where multiple users work on different document sections, recent modifications may be visually emphasized to direct user attention to areas requiring review. Some implementations may further provide a dynamic preview of document updates, ensuring that users consistently view the most relevant information without manual searching.

Authorship identification provides insights into the origin of modifications within a document. In collaborative systems, each text segment may be associated with a visual indicator reflecting the author's identity. This feature facilitates accountability and transparency, allowing users to track changes, understand the context of modifications, and communicate effectively with contributors. In network-based spreadsheet applications, real-time visual cues may highlight the last user who edited a particular section, thereby reducing conflicts and enhancing coordination.

The disclosed system is applicable across various domains. In educational environments, students and instructors may leverage real-time updates and authorship tracking in group projects, ensuring visibility into contributions. In business settings, teams collaborating on reports, proposals, or presentations can efficiently monitor changes and maintain document integrity. In software development, version control systems may incorporate these features to provide developers with insights into code modifications, streamlining collaboration and minimizing integration issues.

By integrating visualized data freshness, text freshness, and authorship identification, the disclosed system enhances content management in collaborative environments. These features support efficient tracking of updates, improve content differentiation, and optimize workflows, addressing common challenges in shared digital workspaces. The described functionalities may be implemented independently or in combination to achieve improved content presentation and user interaction across various applications. The following drawings illustrate the system architecture and workflow processes, and providing a visual representation of how these features are integrated. Each diagram highlights components and interactions, offering a clear understanding of the system's operation and benefits in collaborative settings.

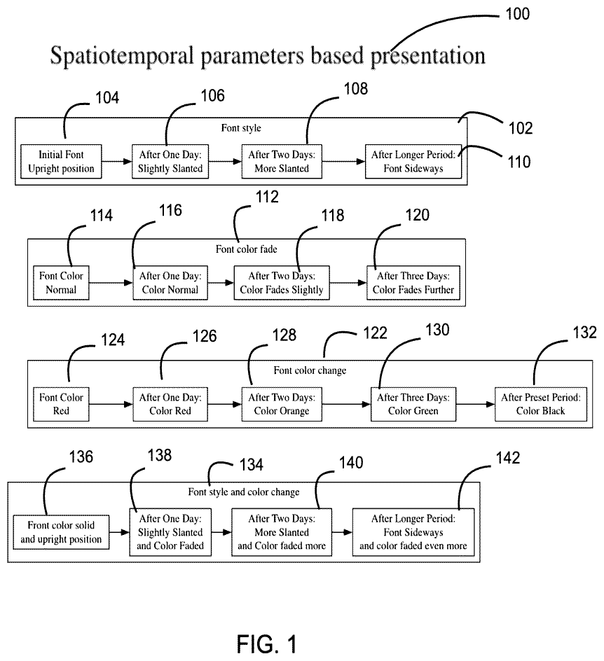

In an example, FIG. 1 illustrates the block diagrams of the spatiotemporal parameter-based presentations for text transformation, depicting progressive changes in font style, color fading, and color transitions over time. The figure includes multiple stages of transformation, such as initial font appearance, gradual slanting, color fading, and eventual changes to both style and color, demonstrating a structured approach to dynamic text presentation. The spatiotemporal parameters-based presentation 100 serves as the foundation for the adaptive content aging system, providing a visual representation of how content ages within a document editing application.

The font style transformation block or circuit 102 is configured to illustrate the progression of font orientation over time. Initially, the font is displayed in an upright position 104, which represents the default state upon content entry. As time elapses, the font orientation changes incrementally. After one day, the font becomes slightly slanted 106, indicating the passage of time. This transformation continues, with the font becoming more slanted after two days 108, and eventually appearing sideways after a longer period 110. This visual cue provides users with an intuitive understanding of the content's age, aligning with the method of altering font orientation as described in the claims.

The color fading block or circuit 112 demonstrates how font color fades over time, providing another dimension to the visual aging process. Initially, the font color is normal 114, maintaining its original vibrancy. After one day, the color remains normal 116, but as time progresses, the color begins to fade slightly after two days 118. This fading continues, with the color fading further after three days 120, offering a subtle yet effective indication of aging content. This aspect of the invention supports the claim of gradually fading shades over time, enhancing the user's ability to prioritize tasks based on content recency.

The font color change transformation block 122 illustrates a dynamic color transition that occurs over a predefined period. The font color starts as red 124, a vibrant hue that signifies new content. After one day, the color remains red 126, but transitions to orange after two days 128, and then to green after three days 130. Eventually, the color changes to black after a preset period of 132, indicating that the content is no longer recent. This color transition provides a clear visual timeline, aiding users in distinguishing between new and old content, as outlined in the claims regarding color changes from red to black.

The combined font style and color change transformation block 134 integrates both font orientation and color changes, offering a comprehensive visual representation of content aging. Initially, the font is solid and upright 136. After one day, the font becomes slightly slanted and the color fades 138. This transformation continues, with the font becoming more slanted and the color fading more after two days 140. After a longer period, the font appears sideways and the color fades even more 142. This combined transformation provides a robust visual cue, enhancing the user's ability to manage document content effectively.

The adaptive content aging system is designed to be implemented within document editing applications, such as spreadsheets and word processors. The system tracks the time elapsed since content entry and automatically adjusts the visual presentation of the content based on predefined rules. This dynamic alteration of content appearance serves as a visual timeline, allowing users to quickly assess the age of document entries and prioritize tasks accordingly.

Potential applications of embodiments of the present disclosure can include any digital document management system where tracking the age of content is beneficial. This could include project management tools, collaborative document editing platforms, and personal productivity applications. The system's ability to provide immediate visual cues regarding content age can significantly enhance user productivity and organization, reducing the likelihood of missed deadlines and improving task prioritization.

By providing a clear visual representation of content age, users can more easily manage their documents and prioritize tasks. The customizable nature of the system allows users to tailor the visual transformations to their preferences, ensuring that the system meets diverse user needs. Additionally, the system's integration into existing document editing applications means that users can benefit from enhanced document management without the need for additional software or user input/settings.

This fading effect serves as a visual indicator of the content's age, allowing users to easily discern newer entries from older ones. The fading process is automated and follows predefined rules that can be customized according to user preferences or system defaults. This feature is particularly useful in collaborative environments where multiple users contribute to a document, as it helps maintain clarity and organization.

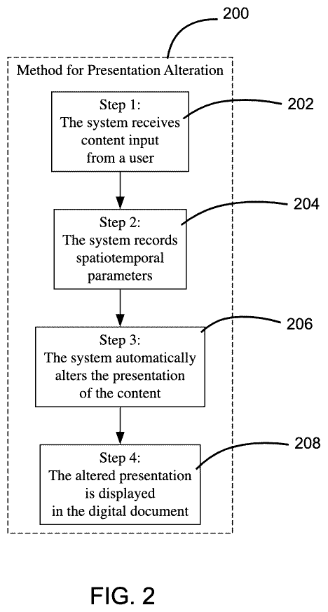

FIG. 2 illustrates a method for presentation alteration based on spatiotemporal parameters. The method is depicted through a series of steps that guide the transformation of content presentation within a digital document. This transformation provides users with visual cues regarding the age and relevance of the content.

The method begins with step 1, represented by block 202, where the system receives content input from a user. This step involves the initial entry of data into a document editing application, such as a word processor or spreadsheet. The system is configured to detect this input and initiate the subsequent processes that will lead to the dynamic alteration of the content's presentation.

In Step 2, depicted by block 204, the system records spatiotemporal parameters associated with the content input. These parameters include the time of input, which determines the subsequent alterations in presentation. The system may also record additional parameters such as the location of the input within the document and user identification, particularly in collaborative environments. This data serves as the foundation for the adaptive content aging process.

Step 3, shown in block 206, involves the automatic alteration of the content's presentation. Based on the recorded spatiotemporal parameters, the system modifies the visual attributes of the content. This can include changes in font orientation, color, and shade. For instance, the font may gradually rotate from upright to sideways, or the color may transition from vibrant to neutral over time. These changes are governed by predefined rules that correlate the elapsed time with specific visual transformations.

Step 4, represented by block 208, displays the altered presentation in the digital document. The system ensures that the modifications are visually rendered within the document, providing users with immediate feedback on the age of the content. This visual representation aids users in distinguishing between new and old entries, thereby enhancing document management and task prioritization.

Some advantages of the embodiments according to the present disclosure an include improved user productivity and organization by offering intuitive visual indicators of content age. Users can quickly assess the relevance of document entries, facilitating better decision-making and deadline management. Additionally, the system's flexibility in customization allows it to cater to a wide range of document management needs, making it a versatile tool for both individual and collaborative environments.

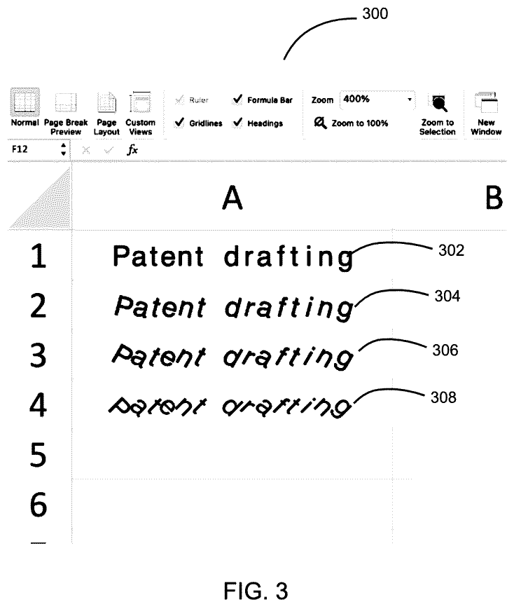

FIG. 3 illustrates an application of spatiotemporal parameters through the progressive modification of text presentation within a spreadsheet application. This figure demonstrates the changes in text appearance over time to visually represent the age of the content. The visual view of progressive text transformation is depicted in element 300, which shows the evolution of text from its initial state to a more distorted form as time progresses.

The initial text appearance, labeled as 302, is presented in a standard upright font. This represents the default state of the text upon entry into the spreadsheet application. At this stage, the text is configured to appear conventionally, providing a baseline visual style for newly entered content. This initial state is crucial for establishing a reference point from which subsequent transformations can be measured.

As time elapses, the first transformation occurs, as shown in label 304, where the text becomes slightly italicized. This transformation is indicative of the passage of time and serves as an early visual cue to the user that the content is aging. The slight italicization is designed to be subtle yet noticeable, ensuring that users can easily discern the relative age of the content without it being overly intrusive.

Further progression in time leads to the second transformation, depicted in label 306, where the text exhibits an increased slant. This increased slant represents a more advanced stage of content aging, providing a stronger visual indication that the content is becoming older. The transformation is designed to be gradual, allowing users to intuitively understand the aging process through the visual changes in text orientation.

After a long period, the text undergoes a more pronounced distortion, as illustrated in label 308, where the text appears in a “sleep” position. This final transformation signifies that the content is significantly aged, offering a clear visual marker that the information may no longer be current. The “sleep” position is a metaphorical representation of the content's dormancy, encouraging users to review or update the information as necessary.

The system described herein is designed to automatically alter the presentation of content based on spatiotemporal parameters, such as the time elapsed since the content was inputted by one or more users. This method is applicable to digital documents, including spreadsheets presented in the example, and word processing documents, where the visual presentation comprises elements such as colors, shades, and fonts. The spatiotemporal parameters include the time of input, which is used to trigger the gradual changes in visual style.

Users can quickly identify outdated content and prioritize updates accordingly. The customizable nature of the system ensures that it can be tailored to meet diverse user needs, making it a versatile tool for various document editing applications. By providing a clear visual representation of content age, the system aids in maintaining the relevance and accuracy of information within digital documents.

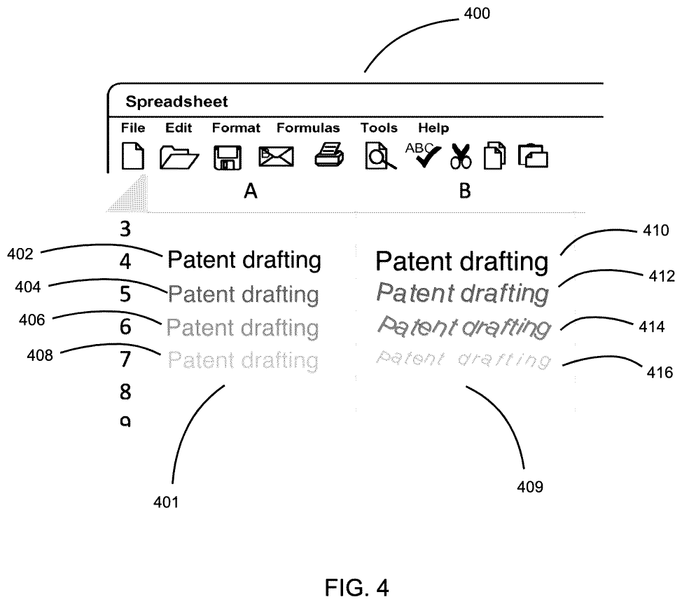

FIG. 4 illustrates some other embodiments of spatiotemporal parameters through the progressive modification of text presentation within a spreadsheet application. The figure shows changes such as text color fading and a combination of fading with slanting to visually represent the age of the content. The spreadsheet interface 400 is depicted with various stages of text transformation, demonstrating the dynamic visual representation of content aging.

The spreadsheet interface 400 serves as an environment where the adaptive content aging system is implemented. This interface is configured to display text transformations that occur over time, providing users with visual cues about the age of the content. The interface is designed to integrate seamlessly with existing spreadsheet applications, allowing users to benefit from enhanced document management without disrupting their workflow.

On the left side of the interface, as indicated by label 401, the font fades over time. Initially, the text is bold and upright, as shown in label 402. This initial state represents newly entered content, which is visually distinct to capture the user's attention. As time progresses, the font begins to fade slightly, as depicted in label 404. This gradual fading continues, with the font becoming more faded over time, as shown in label 406, until it is almost invisible, as indicated by label 408. This fading effect serves as a visual timeline, indicating the content's age and helping users prioritize tasks based on the recency of the information.

The right side of the interface, represented by label 409, demonstrates a combination of font fading and slanting over time. Initially, the text is bold and upright, as shown in label 410. As time elapses, the text begins to fade slightly and becomes italicized, as depicted in label 412. This transformation continues, with the font fading further and the slant becoming more pronounced, as shown in label 414. Eventually, the text exhibits a significant slant and fade, as indicated by label 416. This dual transformation provides an additional layer of visual information, allowing users to quickly assess the age of the content and make informed decisions about its relevance, without losing actual content of the digital document or the need to delete older content.

By allowing colors to transition from vibrant to neutral over time, and by adjusting font orientation from upright to slanted, the system provides a comprehensive visual indication of content aging. This approach is customizable, enabling users to select preferred color schemes, font styles, and time intervals, thereby tailoring the system to their specific needs and preferences.

Various embodiments can be implemented in various document editing applications, including collaborative environments where multiple users contribute content. The system can differentiate inputs from different users or locations by applying distinct visual styles based on user identification or content location. This feature enhances collaborative document management by providing clear visual distinctions between contributions, while also indicating the age of each entry.

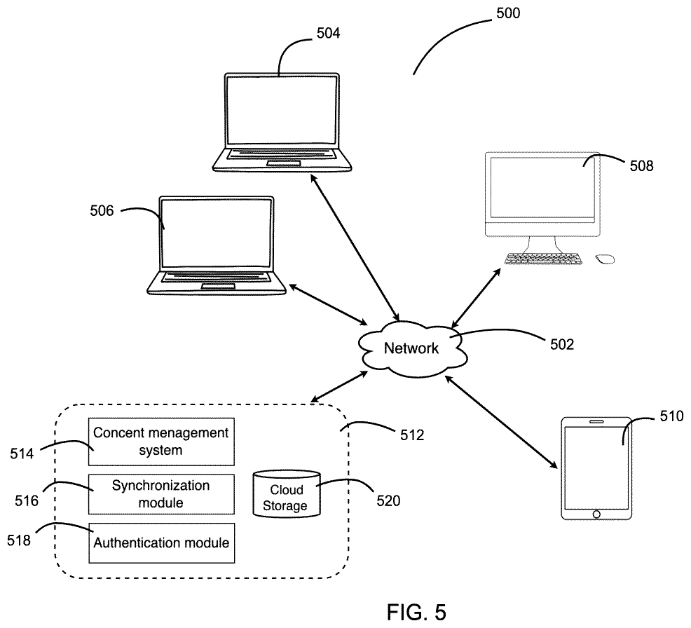

FIG. 5 illustrates a network-based collaborative editing and content management system architecture 500. This architecture is designed to facilitate seamless document editing and management across multiple computing devices, including laptop computers 504 and 506, a desktop computer 508, and a tablet device 510, all interconnected via a network 502. The system integrates several key components, including a collaborative editing computer management system 512, a content management module 514, a content synchronization module 516, an authentication module 518, and cloud storage 520. These components work in concert to provide users with efficient data access, synchronization, and secure authentication across various devices.

The network 502 serves as the backbone of the system, connecting multiple computing devices to enable collaborative document editing. This network can be implemented using various technologies, such as local area networks (LAN), wide area networks (WAN), or the internet, providing flexibility in deployment. The network 502 ensures that all connected devices can communicate and share data seamlessly, facilitating real-time collaboration among users.

A first laptop device, labeled as 504, and a second laptop device, labeled as 506, are configured to connect to the network 502, allowing users to access and edit documents collaboratively. These devices can run document editing applications that integrate with the system architecture 500, enabling users to input, modify, and manage content efficiently. The laptops can be equipped with software that supports the adaptive content aging system, allowing users to benefit from dynamic visual cues indicating the age of document content.

The desktop computer 508 provides a robust platform for document editing and management. Like the laptops, the desktop computer is configured to connect to network 502, enabling users to participate in collaborative editing sessions. The desktop computer can also serve as a central hub for managing document versions and tracking changes made by different users, enhancing the overall document management process.

The tablet device 510 offers a portable solution for users who need to access and edit documents on the go. By connecting to the network 502, the tablet device allows users to participate in collaborative editing sessions from virtually any location. The network 502 ensures that the tablet can synchronize changes in real time, providing a seamless editing experience similar to that on laptops and desktops. The type of the network can vary, including Wi-Fi, cellular networks, or other wireless technologies, ensuring that users have the flexibility to connect from different environments. This adaptability helps to maintain productivity and collaboration, regardless of the user's location.

The collaborative editing computer management system 512 acts as the central coordinator for all editing activities. It manages user sessions, tracks document changes, and ensures that edits made by different users are merged correctly. This system also handles conflict resolution, ensuring that simultaneous edits do not result in data loss or inconsistencies.

The content management module 514 is responsible for organizing and storing documents, providing users with easy access to files, and ensuring that the latest versions are always available. It integrates with cloud storage 520 to offer scalable and secure storage solutions, allowing users to store large volumes of data without local constraints.

The cloud storage 520 also facilitates real-time synchronization, ensuring that any updates made to documents are immediately reflected across all user devices. This seamless integration enhances collaboration by allowing multiple users to work on the same document simultaneously, without the risk of data loss or version discrepancies. Additionally, the cloud storage module implements robust security measures, such as encryption and access controls, to protect sensitive information from unauthorized access.

The content synchronization module 516 ensures that all devices have the most up-to-date versions of documents. It handles the real-time propagation of changes across devices, minimizing latency and ensuring that all collaborators are working with the latest information. Additionally, it resolves conflicts by merging changes intelligently and provides version history for easy rollback if needed.

The authentication module 518 provides secure access control, verifying user identities and managing permissions. This module helps to maintain the security and privacy of documents, ensuring that only authorized users can access and edit sensitive information. Additionally, it logs access attempts and alerts administrators to any suspicious activity, further enhancing the system's security measures. It also supports multi-factor authentication to add an extra layer of protection, ensuring that user credentials are not easily compromised.

Overall, the architecture 500 can be configured to provide a comprehensive solution for collaborative editing and content management, leveraging network connectivity and cloud technologies to enhance productivity and collaboration across diverse devices. It integrates seamlessly with existing workflows, ensuring data security and real-time updates while offering user-friendly interfaces and customizable features to meet the needs of various industries. Its robust infrastructure supports scalability and adaptability, making it ideal for both small teams and large enterprises. Additionally, the platform's advanced analytics tools provide valuable insights into user engagement and content performance, enabling organizations to optimize their processes and drive innovation.

In practical applications, this disclosure can be implemented in any collaborative document editing software, such as Microsoft Excel™ or Google Sheets™, or customized for specific organizational needs using APIs and integration tools, where multiple users are involved in data entry and management. The system's ability to automatically adjust the presentation of content based on user input and time elapsed offers significant advantages in collaborative environments, improving both individual and team productivity.

Various embodiments of the present disclosure also support the customization of visual cues based on user preferences. Users can select different color schemes, font styles, and time intervals for content aging, allowing for a personalized document experience. This flexibility ensures that the system can be adapted to suit the specific needs and preferences of individual users or organizations.

In addition to visual presentations, the system can also incorporate audio presentations. Over time, the audio associated with a content entry can transition to a “sleepy” tone, providing an auditory cue that complements the visual changes. This feature can be particularly beneficial for users who rely on auditory signals for task management and organization.

By providing clear visual and auditory cues about the age of content entries, the system enhances task management and deadline tracking, reducing the likelihood of missed deadlines or overlooked tasks. Furthermore, the system's ability to differentiate inputs from different users based on location or user identification adds layer of organization and clarity to collaborative projects.

The method further includes a specific implementation where the colors of the content change gradually over time. Initially, the content may be displayed in a vibrant color such as red, which then transitions to orange, green, and eventually black as more time elapses. This color transition serves as a visual indicator of the content's age, helping users prioritize tasks based on their recency.

Another embodiment of the disclosure focuses on the modification of font styles over time. When content is first entered, it is displayed in a normal, upright font. As time progresses, the font orientation changes, becoming slightly slanted on the second day and more slanted by the third day. Eventually, the font may appear sideways, resembling a “sleeping” state, which visually signifies that the content is older. This visual transformation not only indicates the age of the content but also adds an element of visual interest to the document, making it easier for users to engage with and interpret the information.

In addition to visual transformations, the system allows for user customization. Users can select different color schemes, font styles, and time intervals for content aging, tailoring the system to their specific preferences and needs. This flexibility enhances the user experience and ensures that the system can be adapted to various document editing applications.

The system is designed to be highly customizable, allowing users to select initial font styles and colors at the time of content input. As time elapses, the system automatically adjusts these attributes, providing a dynamic and personalized user experience. This customization feature ensures that the system can adapt to various user preferences and document types, making it versatile and widely applicable.

In collaborative environments, the system can differentiate inputs from different users by utilizing spatiotemporal parameters such as location and user identification. This differentiation is achieved by presenting texts in fonts and colors that are automatically determined based on these parameters. As the content ages, the fonts and colors further change, providing a clear indication of both the age and origin of the content.

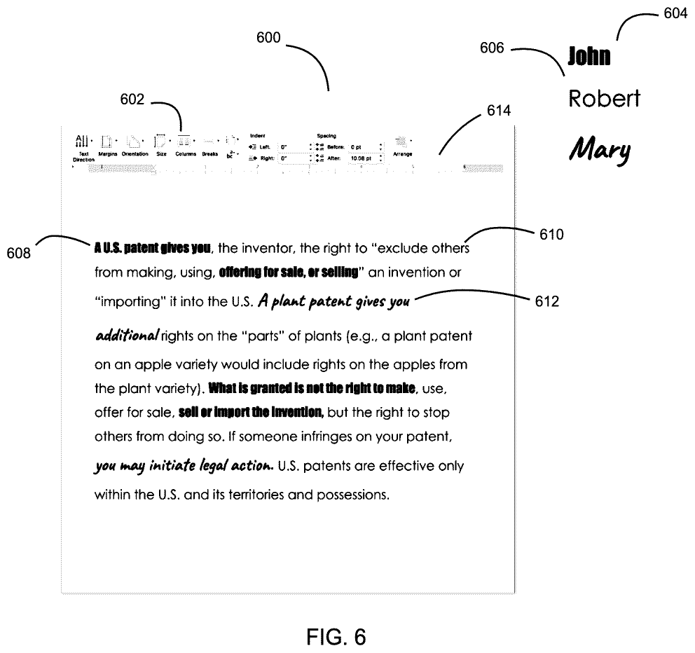

FIG. 6 illustrates a text formatting method that applies different font styles to differentiate content created or edited by different clients, according to one embodiment. This figure demonstrates a system where various font styles are utilized to visually distinguish content contributions from different users within a digital document. The system is designed to enhance collaborative document editing by providing clear visual cues about the origin of each piece of content. Each client is assigned a unique font style, such as bold, italic, or underline, allowing users to easily identify who made specific changes or additions. This method not only improves readability but also facilitates efficient tracking of document revisions and contributions.

The text editor interface 602 is depicted with formatting options that allow users to apply distinct font styles to content. This interface serves as the primary platform where users interact with the document, inputting and editing content. The interface is configured to support various formatting options, enabling users to customize the appearance of text based on user-specific or system-defined rules. These options include changing the font type, size, and color, and applying effects such as bold, italic, and underline. Additionally, users can adjust paragraph alignment, line spacing, and indentation to enhance document layout.

Module 600 illustrates the application of different font styles to content created by different users. Example names formatted distinctly, such as John, Robert, and Mary, are shown in module 606. Each name is presented with a unique font style, demonstrating the system's capability to automatically apply different formatting rules based on user identification. This feature enhances personalization and improves user experience by visually distinguishing content contributions.

This differentiation is helpful in collaborative environments where multiple users contribute to a single document. By assigning unique font styles to each user, the system provides a clear visual representation of individual contributions, facilitating easier content management and review. Additionally, this approach enhances accountability and ensures that each user's input is easily identifiable, promoting transparency and efficient collaboration. Furthermore, it allows for quick identification of authorship, making it easier to address questions or feedback to the appropriate contributor. This method also aids in tracking changes and maintaining a coherent document structure, ultimately improving the overall workflow and productivity in collaborative projects.

In the example shown, different font styles are applied to user name 604, such as bold for John 608, normal for Robert 610, and italic for Mary 612. The bold text by user John 608 exemplifies one of the formatting styles that can be applied to text entries. In this instance, the system has automatically assigned a bold font style to content created by John, providing a clear visual distinction from other users' contributions.

Normal text by user Robert 610 is another example of the system's ability to apply specific formatting styles based on user input. In this case, the system has chosen a standard font style for Robert's contributions, maintaining consistency with the overall document layout while still differentiating his input from others. Italic text by user Mary 612 illustrates yet another formatting option available within the system. By applying an italic font style to Mary's entries, the system effectively distinguishes her contributions from those of other users, supporting collaborative editing and content management.

This differentiation not only aids in identifying the author of each content piece but also enhances the document's readability by visually segmenting contributions. The system is configured to automatically apply these styles based on user identification, ensuring consistency across the document. Additionally, this automated styling reduces the need for manual formatting, saving time and minimizing errors. By maintaining a uniform appearance, the document becomes more professional and easier to navigate, allowing readers to quickly associate content with its respective author.

The system for dynamically altering text presentation 614 is designed to automatically adjust the visual attributes of text over time. This dynamic alteration is based on predefined spatiotemporal parameters, such as the time elapsed since content entry. The system can modify text attributes like color, shade, and orientation to indicate the age of the content, providing users with intuitive visual cues about the document's temporal structure. It can enhance user engagement by making older content appear less prominent while highlighting newer information. This approach helps users quickly identify recent updates or changes, improving overall document navigation and comprehension.

The system effectively enhances the readability and usability of documents by visually distinguishing content based on its age. By dynamically adjusting text attributes, it aids users in focusing on the most relevant and up-to-date information, thereby streamlining the process of information retrieval and decision-making. This innovative approach not only improves user experience but also optimizes the way information is presented and consumed.

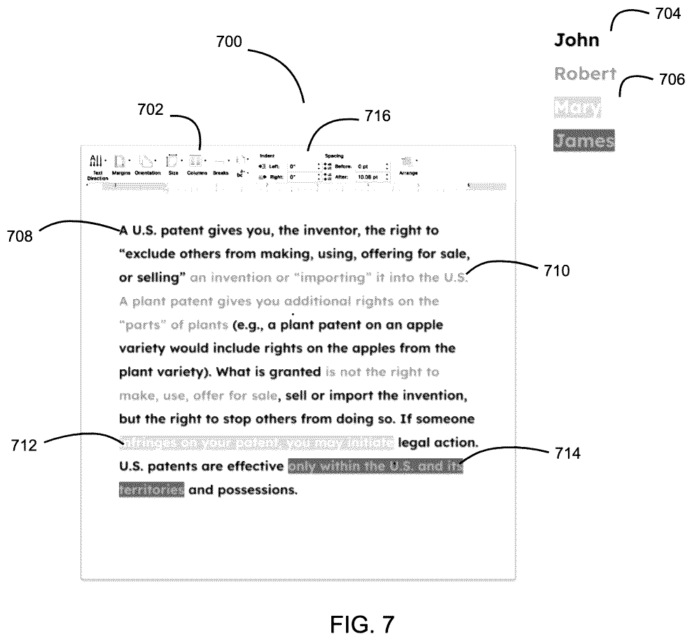

FIG. 7 illustrates a text formatting method that applies different font colors, font background color, or transparency to differentiate content created or edited by different clients, according to one embodiment. This figure provides a visual representation of how the system can be implemented to enhance document management by visually distinguishing content contributions from various users. The method is particularly useful in collaborative environments where multiple users interact with a single digital document.

The text editor interface 702 is depicted with formatting options that allow users to apply different visual styles to text entries. This interface is configured to enable users to select and apply various formatting attributes such as font color, background color, and transparency. These formatting options are integral to the system's ability to visually differentiate content based on user input, thereby enhancing the collaborative editing process.

In the embodiment shown, different font colors or background colors are applied to user names, as indicated by label 704. This feature allows for immediate visual recognition of content origin, facilitating easier tracking of contributions in a collaborative document. By associating specific colors with individual users, the system provides a clear and intuitive method for identifying the source of each content entry.

Example names with different colors, such as John, Robert, Mary, and James, are illustrated in label 706. This example demonstrates how the system assigns distinct colors to different users, with John's text appearing in black, Robert's in red, Mary's with a yellow background, and James's with a blue background. This differentiation is achieved through the system's ability to dynamically alter text presentation based on user identification.

The text with black color created by John, as shown in label 708, exemplifies the default color assignment for a user. This feature is beneficial in environments where default settings are preferred for certain users or roles. The system can be configured to assign default colors based on user preferences or organizational standards.

Text with red color created by Robert, as depicted in label 710, highlights the system's capability to apply vibrant colors to emphasize recent or important contributions. This feature can be utilized to draw attention to specific entries, thereby aiding in prioritizing tasks or identifying critical updates within the document.

Text with a yellow background created by Mary, as indicated in label 712, showcases the use of background colors to differentiate content. This approach provides an alternative to font color changes, offering additional flexibility in visual customization. Background colors can be particularly effective in highlighting sections of text without altering the text color itself.

Text with a blue background created by James, as shown in label 714, further illustrates the use of background colors for user differentiation. This method can be employed in scenarios where color contrast is essential for readability or where specific color schemes are required to meet accessibility standards.

The system for dynamically altering text presentation to differentiate contents created by different users, as described in label 716, is configured to automatically adjust text presentation based on user input, providing a seamless and efficient method for managing collaborative documents. The system's adaptability ensures that it can be tailored to meet the diverse needs of various users and organizations.

The method for the presentation of content in a digital document involves automatically altering the presentation based on spatiotemporal parameters of the content inputted by one or more users. This approach allows for dynamic updates to the document's visual presentation, ensuring that content remains relevant and easily identifiable over time. The method applies to both spreadsheets and word-processing documents, providing a versatile solution for a wide range of document types.

The visual presentation comprises at least one of the colors, shades, or fonts, allowing for a comprehensive range of customization options. Users can select from a variety of visual styles to suit their preferences or organizational requirements, ensuring that the system can be effectively integrated into existing workflows.

Colors can gradually change over time elapsed since the time of input of the content, transitioning from vibrant to neutral shades. This gradual transformation serves as a visual timeline, helping users to quickly assess the recency of document entries and make informed decisions based on content age.

Fonts are initially normal and upright at the time of input, with the potential to be automatically rotated sideways over time. This feature provides an additional visual cue for content aging, enhancing the user's ability to distinguish between new and old entries.

Shades can gradually fade over time, becoming lighter as the content ages. This subtle change in presentation offers a non-intrusive method for indicating content age, ensuring that the document remains visually appealing and easy to navigate.

The system also supports audio presentation, with the option for audio cues to transition into a sleepy tone over time. This auditory feature provides an alternative method for indicating content age, catering to users who may benefit from audio cues in addition to visual indicators.

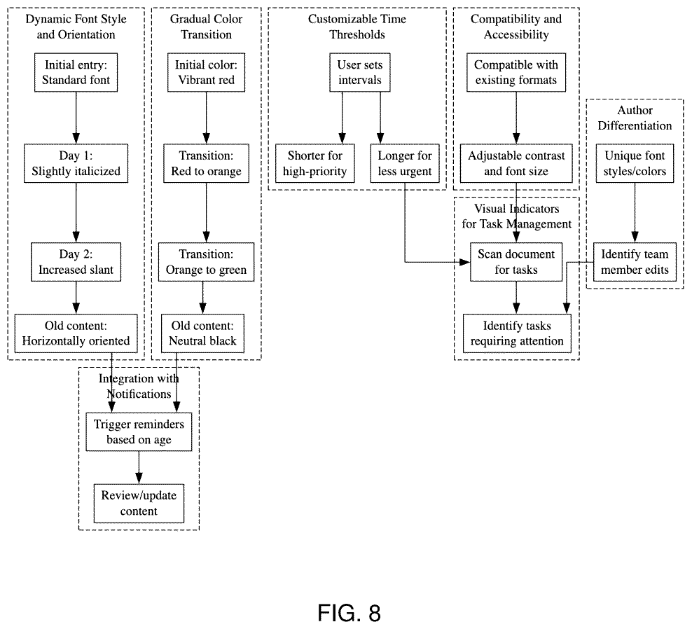

FIG. 8 illustrates the overview of the embodiments of the disclosure to dynamically alter the presentation of content in a digital document, representing the freshness of the text. The diagram, labeled 800, provides an overview of the process by which content presentation is automatically adjusted based on spatiotemporal parameters. This method is particularly applicable to digital documents such as spreadsheets or word-processing documents, as indicated by label 806.

The method for the presentation of content in a digital document, as depicted by label 802, involves automatically altering the presentation based on spatiotemporal parameters of the content inputted by one or more users. This alteration is achieved through a combination of visual, text, and audio presentations, which adapt over time to reflect the age of the content. The system is designed to enhance readability and user interaction by providing clear visual cues regarding the temporal status of document entries.

The visual presentation, as indicated by label 808, comprises dynamic changes in colors, shades, and fonts. Label 810 specifies that these visual elements are integral to the presentation method. Colors, for instance, transition from red to orange, to green, and finally to black as time elapses, as shown by labels 814 and 816. This gradual color change serves as a visual indicator of the content's age, allowing users to quickly assess the freshness of the information.

Fonts, initially normal and upright at the time of content input, are configured to rotate sideways over time, as if “falling asleep,” as described by labels 818 and 820. This font transformation provides an additional layer of visual indication, complementing the color changes and enhancing the user's ability to differentiate between new and old content.

In addition to visual cues, the system incorporates audio presentations, as noted by label 822. Over time, the audio output transitions to a “sleepy” tone, as indicated by label 824, further reinforcing the temporal status of the content. This multi-sensory approach ensures that users receive consistent and intuitive feedback regarding the age of document entries.

Shading effects, as described by labels 826 and 828, also play a role in the presentation method. Text shades gradually fade and become lighter over time, providing a subtle yet effective means of indicating content age. This fading effect is particularly useful in collaborative documents, where multiple users may contribute content over time.

The method also considers spatiotemporal parameters, including the time of input and user location or identification, as shown by labels 812 and 832. These parameters enable the system to personalize content formatting, ensuring differentiation among multiple contributors in a collaborative environment. This personalization could help maintain clarity and organization in documents with inputs from various users.

In collaborative documents, as depicted by label 834, the presentation comprises texts that are automatically formatted based on user identity and location. This feature, highlighted by label 836, ensures that inputs from different contributors are easily distinguishable, thereby enhancing document management and collaboration.

Overall, this adaptive content aging system offers numerous advantages and benefits. By providing dynamic visual and audio cues, the system enhances users' ability to manage tasks and deadlines effectively. The customizable nature of the system allows users to tailor the presentation to their preferences, further improving user experience and productivity. Potential applications of this disclosure extend to various document management platforms, including but not limited to Microsoft Excel and Word, where efficient content management is essential.

Referring back to FIG. 1, which is an illustration of a document editing application interface, showcasing the initial entry of new content with a specified font style and color, the document interface 100 serves as the workspace where users input and manage their data. Within this interface, new content entry 102 is highlighted, representing the user's initial input into the document. This content is displayed in an initial font style and color 104, which is predetermined to provide a baseline visual representation.

The document interface 100 is configured to facilitate user interaction with the document editing application. It provides a comprehensive view of the document, allowing users to input, edit, and manage content efficiently. The interface is equipped with various tools and features that enhance the user experience, such as formatting options, editing tools, and navigation aids. The interface's layout is intuitive, ensuring that users can easily locate and utilize the available functionalities.

New content entry 102 can be an initial component of the document editing process. It represents the user's initial input, which can set the tone for the subsequent visual transformations that indicate the content's age. This entry is detected by the system, triggering the dynamic aging process. The system records the timestamp of the entry, which serves as the basis for the visual changes that occur over time. This feature is particularly beneficial for users who need to automatically track the age of their entries for task management and deadline tracking purposes.

The initial font style and color 104 can be selected to provide a clear and distinct visual representation of new content. This initial presentation serves as a reference point for the subsequent visual transformations. The choice of font style and color can be customized according to user preferences, allowing for a personalized document editing experience. This customization capability ensures that the system can accommodate a wide range of user needs and document types.

The method for dynamically indicating the age of content within a document editing application involves several steps. Initially, the system detects the entry of new content into the document. This detection is useful for initiating the aging process. Once the entry is detected, the content is displayed in a specified font style and color, providing a visual indication of its newness. Over time, the system automatically modifies the font style and/or color according to predefined rules, thereby providing a visual indication of the content's age.

Some embodiments of the disclosure involve modifying the font style by changing its orientation over time. Initially, the font may appear upright, but as time elapses, it gradually becomes slanted and eventually sideways. This transformation provides a clear visual cue to the user, indicating the content's age and helping them prioritize tasks accordingly. This feature is particularly useful for users who need to manage multiple entries with varying levels of urgency with minimal or no user settings.

Another embodiment involves changing the font color over time. The color transition can start with a vibrant hue, such as red, and gradually shift to more subdued tones like orange and green. This color change provides an additional layer of visual differentiation, allowing users to quickly assess the age of their entries. The color scheme can be customized to suit individual preferences, ensuring that the system remains flexible and adaptable to different user needs.

The system can also include a tracking module or circuit configured to monitor the time elapsed since content entry. This module is responsible for recording the timestamp of each entry and calculating the time elapsed. The tracking module works in conjunction with a presentation module, which alters the appearance of the content based on the time elapsed. This collaboration between modules ensures that the system provides accurate and timely visual cues to the user.

The presentation module or circuit is further configured to allow user customization of font styles, colors, and time intervals for content aging. This customization capability enhances the system's utility, allowing users to tailor the visual transformations to their specific needs. Users can choose from a variety of font styles and colors, as well as set custom time intervals for the aging process. This flexibility ensures that the system can accommodate a wide range of document types and user preferences.

In addition to indicating the age of content, the system can also distinguish entries made by different users using unique visual identifiers. This feature is particularly useful in collaborative environments, where multiple users may be working on the same document. By providing distinct visual cues for each user's entries, the system enhances collaboration and communication among team members.

Various embodiments of the present disclosure can offer numerous benefits and advantages. By providing dynamic visual cues, the system helps users manage their tasks and deadlines more effectively. It reduces the likelihood of missed deadlines and forgotten tasks, thereby improving productivity and efficiency. The system's customization capabilities ensure that it can be tailored to suit a wide range of user needs and document types, making it a versatile tool for document editing applications.

In the novel solution for content aging in document editing applications according to some embodiments of the present disclosure, by dynamically altering the visual presentation of text entries based on the time elapsed since their creation, the system offers a powerful tool for task management and deadline tracking. Its flexibility and customization capabilities ensure that it can be adapted to suit various user needs, making it an invaluable asset for both individual and collaborative document editing environments.

The progression of font orientation over time, according to some embodiments of the present disclosure, can include various stages of font orientation: upright font orientation, slightly slanted font orientation, and sideways font orientation. These stages visually represent the aging of content within a document editing application, providing users with an intuitive method to track the temporal context of their entries. This visual transformation according to some embodiments of the present disclosure can assist users in managing tasks and deadlines effectively.

The upright font orientation represents the initial state of the content when it is first entered into the document. At this stage, the font appears in its standard, upright form, which is the default presentation for newly entered content. This initial state serves as a baseline for users to identify fresh entries in their documents, ensuring that they can easily distinguish between new and older content.

As time progresses, the font transitions to a slightly slanted orientation. This intermediate stage occurs after a predefined period, such as the second day after the content's entry. The slight slanting of the font serves as a subtle visual cue to the user, indicating that the content is no longer new but not yet old. This stage helps users prioritize tasks that are approaching their deadlines, allowing them to manage their workload more efficiently.

A final stage in the font orientation progression can be the sideways orientation. This stage is reached after a longer period, signifying that the content is now considered old. The sideways orientation acts as a strong visual indicator, alerting users to content that may require attention or review. By providing such a clear distinction between different stages of content age, the methods, systems, and apparatuses provided by various embodiments of the present disclosure can aid users in maintaining an organized and timely approach to their document management.

The method of dynamically indicating the age of content through font orientation changes is a novel approach compared with traditional document editing systems. By incorporating these visual transformations, users are empowered to quickly assess the age of their document entries, facilitating better task management and deadline tracking. This system can be particularly beneficial in environments where timely decision-making and task prioritization are critical, such as in project management, academic settings, and collaborative workspaces.

In addition, or alternative, to font orientation changes, various embodiments of the present disclosure provide automatic modifications in font color and size over time, providing further visual differentiation based on content age. For example, the font color may transition from red to orange to green, while the font size may gradually decrease, simulating a fading effect. These additional transformations enhance the system's flexibility and adaptability, allowing users to customize the visual cues according to their preferences and specific document types.

The potential applications can span various industries and use cases. In educational settings, teachers can use the system to track student submissions and assignments, ensuring timely feedback and grading. In corporate environments, project managers can utilize the visual cues to monitor task progress and deadlines, improving team efficiency and productivity. Moreover, the system's ability to distinguish content entries made by different users using unique visual identifiers adds another layer of functionality, making it ideal for collaborative projects and shared documents.

Various embodiments of the present disclosure can offer significant advantages over existing document editing systems by providing a dynamic and intuitive method for content aging. The visual transformations not only enhance user experience but also improve organizational efficiency, making it a valuable tool for anyone who relies on document editing applications for task management and deadline tracking.

In some embodiments, the automatic changes can be in font color from red to orange to green over a predefined time period, which is an example method for dynamically indicating the age of content within a document editing application. The diagram includes three labeled stages of font color transformation: initial red font color, intermediate orange font color, and final green font color. This visual progression serves as a temporal indicator, allowing users to easily identify the age of content entries based on their color, thus aiding in task management and deadline tracking.

The initial red font color represents the starting point for newly entered content within a document. Upon entry, the content is displayed in this vibrant color to signify its recent addition. This initial state is crucial as it provides a clear visual cue to users that the content is new and may require immediate attention or further action. The choice of red as the initial color is intentional, as it naturally draws the user's eye and emphasizes the importance of the new entry.

As time progresses, the font color transitions to an intermediate orange color. This change occurs after a predefined period, such as one day, and serves as an indication that the content is no longer new but still relatively recent. The orange color acts as a middle ground, alerting users that the content is aging and may soon require review or action. This intermediate stage is essential for maintaining awareness of content timelines without overwhelming the user with too many immediate tasks.

In an example, the font color changes to a final green color, signifying that the content has reached a mature state. This transformation typically occurs after a longer period, such as three days, and indicates that the content is older and may not require immediate attention. The green color provides a calming visual cue, suggesting that the content is stable and can be deprioritized in favor of newer entries. This final stage helps users manage their workload by visually categorizing content based on its age and urgency.

The method of modifying font color over time can provide a simple yet effective way to convey the age of content within a document, enhancing the user's ability to track and manage tasks efficiently. By utilizing a predefined color progression, the system offers a consistent and intuitive approach to content aging, reducing the cognitive load on users and improving overall productivity.

In addition to the color transformation, the system can be customized to accommodate user preferences. Users can select different color schemes, time intervals, and even font styles to suit their specific needs and document types. This flexibility ensures that the system can be tailored to various applications, from personal task management to collaborative project tracking, making it a versatile tool for a wide range of users.

By providing clear visual cues about the age of content, users can quickly assess which entries require immediate attention and which can be deferred. This capability is particularly valuable in environments where timely decision-making is critical, such as project management, academic research, and financial analysis. Moreover, the system's ability to visually distinguish content based on age can help prevent oversight of important deadlines and ensure that tasks are completed in a timely manner.

Various embodiments of the present disclosure offer a novel solution for content aging in document editing applications, providing users with a powerful tool for task management and deadline tracking through dynamic visual transformations of text entries. By integrating this system into existing document editing platforms, users can enhance their productivity and efficiency, ultimately leading to better outcomes in both personal and professional contexts.

A system architecture for content appearance management according to some embodiments of the present disclosure can achieve the desired functionalities. The system can include a tracking module and a presentation module, both of which are integral to managing content appearance based on the time elapsed since content entry. The content appearance management is the overarching process that these modules facilitate, ensuring that users receive visual cues about the age of content within their documents.

The tracking module is designed to monitor the time elapsed since content was first entered into a document. This module operates continuously in the background, recording timestamps for each new entry. By maintaining a precise log of when each piece of content was added, the Tracking module enables the system to determine the appropriate time to initiate changes in the content's appearance. This functionality is crucial for the system's ability to provide dynamic visual indicators of content age, as outlined in the claims.

The presentation module is responsible for altering the appearance of content based on the data provided by the tracking module. This module applies predefined rules to modify font styles, colors, and orientations over time. For instance, text may start in a default font and color, then gradually change to a slanted orientation or shift through a spectrum of colors as days pass. This visual transformation helps users quickly identify the age of content, aiding in task prioritization and deadline management. The Presentation module can be customized to accommodate user preferences, allowing for different visual transformation schemes and time intervals, thus enhancing its adaptability across various applications.

The content appearance management process integrates the functionalities of both the tracking and presentation modules to deliver a seamless user experience. By providing real-time updates to content appearance, this process ensures that users have immediate visual feedback on the age of their document entries. This system is particularly beneficial in environments where tracking the recency of information is critical, such as in project management, academic research, or collaborative workspaces.

Potential applications of the present disclosure can range from individual productivity tools to enterprise-level document management systems. By offering a clear, intuitive method for tracking the temporal context of document entries, the system enhances users' ability to manage tasks and deadlines effectively. Additionally, the ability to customize visual cues ensures that the system can be tailored to meet the specific needs of different users and industries.

Some advantages of various embodiments of the present disclosure include the abilities to provide non-intrusive yet effective visual reminders of content age. Unlike traditional methods that rely on manual tracking or external reminders, this system integrates seamlessly into the document editing process, offering a passive yet powerful tool for time management. Furthermore, by distinguishing content entries made by different users through unique visual identifiers, the system supports collaborative environments where multiple contributors may be working on the same document.

In some approaches according to embodiments of the present disclosure to achieve content management within document editing applications, by leveraging the capabilities of the tracking and presentation modules, the system provides dynamic visual transformations that indicate the age of content entries. This innovation not only enhances individual productivity but also supports collaborative efforts by providing clear visual cues about the origin and age of document entries. The system's flexibility and adaptability make it a valuable tool across a wide range of applications and industries.

Various user customization options are available within the document editing application, which are integral to the dynamic content aging system. A customization interface provides users with the ability to tailor the visual transformation of text entries according to their preferences. This interface includes font style options, allowing users to select from a variety of font orientations and styles that will be applied to text as it ages. Additionally, color scheme options enable users to choose specific color transitions that will occur over time, providing a personalized visual cue system that aligns with individual user needs and preferences.

The customization interface is designed to enhance user experience by offering flexibility in how content aging is visually represented. Users can select from a range of font styles, such as bold, italic, or underlined, and define how these styles change over time. For instance, a user might choose for text to start in a bold font and gradually transition to an italic style as it ages, providing a clear and intuitive indication of content age. This feature is particularly beneficial for users who rely on visual cues to manage tasks and deadlines effectively.

Color scheme options within the customization interface allow users to define a sequence of color changes that text entries will undergo as they age. This feature supports a variety of color transitions, such as shifting from red to orange to green, or any other color sequence that the user prefers. By customizing these color transitions, users can create a visual hierarchy that helps them quickly identify the age of content, facilitating better organization and prioritization of tasks within documents.

The system's ability to allow user customization of font styles, colors, and time intervals for content aging can provide adaptability and user-friendliness. This customization capability ensures that the system can be tailored to suit diverse user requirements and document types, making it applicable across various industries and use cases. Whether used in a corporate setting for project management or in personal applications for organizing daily tasks, the system's flexibility in customization enhances its utility and effectiveness.

In some applications, the dynamic content aging system can be implemented in various document editing platforms, such as Microsoft Excel and Word, to improve task management and deadline tracking. By providing visual cues that indicate the age of content, users can easily distinguish between new and old entries, helping them focus on urgent tasks and avoid missing important deadlines. This system is particularly advantageous in collaborative environments, where multiple users contribute to a document, as it allows for clear identification of recent changes and contributions.

Various embodiments of the present disclosure can extend beyond individual productivity, as they can also support collaborative efforts by providing a clear visual representation of content age and origin. In a team setting, users can quickly identify which entries were made by different contributors, facilitating better communication and coordination. This feature is especially useful in projects with multiple stakeholders, where understanding the timeline of contributions is crucial for effective collaboration and decision-making.

Overall, the dynamic content aging system offers a novel approach to document management by integrating visual transformations that reflect the temporal context of text entries. Its customizable features ensure that it can be adapted to meet the specific needs of users, enhancing its applicability and effectiveness in various scenarios. By providing intuitive visual cues, the system empowers users to manage their tasks and deadlines more efficiently, ultimately improving productivity and organization in both personal and professional settings.

In a collaborative document interface having different user entries, each marked with unique visual identifiers for easy recognition. This interface is designed to facilitate collaborative work by allowing multiple users to contribute to a single document while maintaining clarity about who made each entry. The collaborative document interface serves as a platform where users can input data, comments, or edits, and these contributions are visually distinguished to prevent confusion and enhance productivity.

User A's entry can be highlighted with a unique identifier, which could be a specific color, font style, or icon that distinguishes it from entries made by other users. This identifier serves not only to attribute the content to User A but also to provide a quick visual reference for other collaborators. Such identifiers are crucial in collaborative environments where multiple users may be working on the same document simultaneously, as they help maintain a clear record of contributions and changes.

Similarly, User B's entry can be marked with a different unique identifier, ensuring that all collaborators can easily identify the source of each entry. This system of unique identifiers is particularly beneficial in large teams or projects where tracking individual contributions is necessary for accountability and project management. By visually differentiating entries, the system reduces the likelihood of errors and miscommunications, thereby streamlining the collaborative process.

The functionalities of the presentation module can be configured to distinguish content entries made by different users using unique visual identifiers. This feature is integral to the system and method's goal of enhancing collaborative document editing by providing clear, intuitive visual cues that help users navigate and manage shared content effectively.

A purpose of the collaborative document interface is to improve task management and deadline tracking in collaborative settings. By providing unique visual identifiers for each user's entries, the system allows team members to quickly assess the status of a document, identify pending tasks, and prioritize their work accordingly. This feature is particularly advantageous in fast-paced environments where timely updates and clear communication are essential.

In terms of implementation, the system can be integrated into existing document editing applications, such as Microsoft Word™ or Google Docs™, through a plugin or built-in feature. The unique identifiers can be customized according to user preferences or organizational standards, allowing for flexibility and adaptability across different use cases. This customization capability ensures that the system can meet the diverse needs of various teams and projects.

Potential applications of various embodiments of the present disclosure can extend beyond traditional office environments. They can be used in educational settings to facilitate group projects, in research collaborations to track contributions from different researchers, and in any scenario where multiple stakeholders need to work together on a shared document. The system's ability to provide clear visual cues about the age and origin of content entries makes it a valuable tool for enhancing collaboration and productivity.

Various embodiments of the present disclosure not only can improve the efficiency of collaborative work by reducing confusion and errors but also can enhance accountability by clearly attributing content to specific users. Additionally, the system's dynamic visual transformations provide users with a powerful tool for managing their tasks and deadlines, ultimately leading to better project outcomes and increased satisfaction among team members.

Various embodiments of the present disclosure described herein introduce a novel method and system for visually indicating the age of content within document editing applications, such as spreadsheets and word processors. Unlike systems that focus on collaborative editing and comment navigation, various embodiments of the present disclosure provide a unique approach to content management by dynamically altering the visual presentation of text entries based on the time elapsed since their creation.

The automatic gradual transformation of text characteristics over time, and in some embodiments based on user settings, user profiles, or AI-learning of the users' habits and preferences, can serve as a visual cue to help users quickly discern the age of entries. This is achieved through a series of predefined visual changes, such as font orientation, color, and size, which evolve as time progresses. For example, text entered into a spreadsheet may initially appear in a standard font and color. As days pass, the text may begin to slant, change color, or shrink, indicating its age and helping users prioritize tasks and manage deadlines more effectively.

In addition to addressing collaborative editing features, such as comment navigation and user-specific visual indicators, various embodiments of the present disclosure can provide individual content aging, provide users with a clear, intuitive method to track the temporal context of their entries without relying on external collaboration features, and without additional manual tracking efforts.

Additionally, the system can be customized to accommodate user preferences, allowing for different visual transformation schemes and time intervals. This flexibility ensures that the system can be tailored to suit various user needs and document types, enhancing its utility across different applications.

The novel solution for content aging in document editing applications can therefore provide users with a powerful tool for task management and deadline tracking through dynamic visual transformations of text entries.

The method for dynamically indicating the age of content within a document editing application begins with detecting the entry of new content into a document. Upon entry, the content is displayed in a first specified font style and color, such as a normal font and red color. Over time, the system automatically modifies the font style and/or color of the content according to predefined rules, providing a visual indication of the content's age.

In some embodiments, the font style modification includes changing the orientation of the font from upright to slanted to sideways as time elapses. This gradual change in orientation serves as a visual cue to the user, indicating the relative age of the content. Such a feature is particularly useful in environments where users frequently update documents and need to quickly identify which entries are recent and which are older.

Another embodiment involves modifying the font color over time. Initially, the font may be red, transitioning to orange, then green, and eventually reverting to black after a certain threshold. This color transition provides an intuitive visual timeline for users, allowing them to easily track the age of content entries and prioritize tasks accordingly.

Furthermore, various embodiments of the present disclosure provide a method for automatically modifying the size of the content over time, thereby providing additional visual differentiation based on the content's age. This feature can be particularly beneficial in scenarios where space is limited, and users need to quickly identify older entries that may no longer be relevant.

The system for managing content within a document editing application comprises a tracking module configured to monitor the time elapsed since content entry and a presentation module configured to alter the appearance of the content based on the time elapsed. This configuration provides visual cues to the user regarding the content's age, enhancing their ability to manage tasks and deadlines effectively.

The presentation module is further configured to allow user customization of font styles, colors, and time intervals for content aging. This customization capability ensures that the system can be adapted to meet the specific needs and preferences of different users, making it a versatile tool for a wide range of applications.

Potential applications of some embodiments of the present disclosure can include task management, deadline tracking, and collaborative document editing. By providing clear visual cues about the age of content entries, the system helps users prioritize tasks, manage deadlines, and collaborate more effectively with others.

Systems, methods, and devices provided herein can therefore enhance user productivity by providing an intuitive method for tracking the age of content entries, reduces the likelihood of missed deadlines, and improves task management. Additionally, the system's customization capabilities ensure that it can be tailored to suit the specific needs of different users and applications, making it a valuable tool for a wide range of document editing environments.

The dynamic content aging system can be designed to enhance document editing applications by providing visual cues that indicate the age of content entries. This system is particularly beneficial in environments where users frequently input new content into documents such as spreadsheets and word processors. Various embodiments of the present disclosure provide a mechanism to automatically track when these entries were made, and can address issues of users forgetting when specific entries were made, which can lead to challenges in task management and deadline tracking. Compared with users making manual sideline notes or comments, which can be time consuming for users, various embodiments of the present application provide automatic content aging visual cues.

For example, dynamically altering the visual presentation of text entries based on the time elapsed since their creation can be achieved by implementing a series of predefined visual changes to the text characteristics, such as font orientation, color, and size. For instance, when a user inputs new content into a spreadsheet, the text initially appears in a default font style and color. As time progresses, the system automatically modifies these attributes according to predefined rules, providing a visual indication of the content's age.

In one embodiment, the system modifies the font orientation over time. Initially, the text appears upright. On the second day, the font may become slightly slanted, and by the third day, it becomes more pronouncedly slanted. After a longer period, the font may appear sideways, indicating that the content is older. This gradual transformation serves as a visual cue, allowing users to quickly discern the age of entries and prioritize tasks accordingly.

Another embodiment involves changing the font color over time. The text may start in a vibrant color such as red, which then transitions to orange on the second day, and to green by the third day. After a certain threshold, the font color may revert to black, signifying that the content is no longer recent. This color transition provides an intuitive method for users to track the temporal context of their entries without relying on external collaboration features.

The system is designed to be highly customizable, allowing users to tailor the visual transformation schemes and time intervals to suit their preferences and document types. This flexibility ensures that the system can be adapted to various user needs, enhancing its utility across different applications. Users can select different color schemes, font styles, and time intervals for content aging, making the system versatile and user-friendly.

Various embodiments of the present disclosure also provide a system for managing content within document editing applications, including a tracking module and a presentation module. The tracking module is configured to monitor the time elapsed since content entry, while the presentation module alters the appearance of the content based on this elapsed time. This configuration provides visual cues to the user regarding the content's age, aiding in task management and deadline tracking.

Furthermore, the system can distinguish content entries made by different users using unique visual identifiers. This feature is particularly useful in collaborative environments, where multiple users may be editing the same document. By providing distinct visual cues for each user's entries, the system enhances collaborative task management and accountability.

Potential applications of various embodiments of the present disclosure can range from personal productivity tools to enterprise-level document management systems. They can be integrated into existing document editing applications such as Microsoft Excel™ and Word™, providing users with a powerful tool for managing their tasks and deadlines. The system's ability to provide clear visual cues about the age and origin of document entries makes it an invaluable asset in any setting where effective task management is crucial.

In the novel solution for content aging in document editing applications, by dynamically altering the visual presentation of text entries based on the time elapsed since their creation, the system provides users with a powerful tool for task management and deadline tracking. Its customizable nature and ability to distinguish between different users' entries further enhance its utility, making it a versatile and effective solution for a wide range of applications.

The customization interface within a document editing application can allow users to personalize the visual transformation of document content based on the time elapsed since its entry. The customization interface is designed to enhance user experience by providing a range of options for tailoring the appearance of content, thereby making the system adaptable to individual preferences and needs.

The font style options within the customization interface enable users to select from various font styles that will be applied to content as it ages. This feature is crucial for implementing the method described in the claims, where the font style is modified over time to indicate the age of the content. Users can choose different styles such as upright, slanted, or sideways orientations, which change progressively as time elapses. This visual transformation not only aids in task management but also provides a clear, intuitive indication of content age, helping users prioritize their work effectively.

Color scheme options can be another integral part of the customization interface. These options allow users to define a sequence of colors that will be applied to content over time. For instance, content may initially appear in red, then transition through orange to green, and finally revert to black as it becomes older. This color progression serves as a visual cue, enabling users to quickly assess the recency of document entries. The ability to customize color schemes ensures that the system can accommodate various user preferences and enhance the overall utility of the document editing application.

The system can provide a tracking circuit and a presentation circuit, which can be included in local processing circuits, or implemented in a computing cloud. The tracking circuit can be responsible for monitoring the time elapsed since content entry, ensuring that the system can accurately apply the predefined rules for visual transformation. This module operates seamlessly within the document editing application, providing real-time updates to the presentation module, which then alters the content's appearance accordingly.

The presentation circuit or module can be designed to implement the visual transformations specified by the user through the customization interface. It applies changes to font style, color, and potentially size, as described in the claims, to provide a dynamic indication of content age. This module's capability to allow user customization of these visual elements is a significant advantage, as it enables the system to be tailored to different workflows and preferences, thereby increasing its applicability across various document editing scenarios.

In addition to the primary function of indicating content age, the system can also distinguish entries made by different users using unique visual identifiers. This feature is particularly beneficial in collaborative environments, where multiple users contribute to a single document. By providing distinct visual cues for each user's entries, the system enhances clarity and organization, reducing the likelihood of confusion and improving collaborative efficiency.

Potential applications of various embodiments of the present disclosure can be in any scenarios involving document editing and task management. The methods, systems, and devices can be employed in professional settings, such as project management and team collaboration, as well as in personal contexts, like organizing personal notes or managing household tasks. The system's ability to provide immediate visual feedback on content age makes it an invaluable tool for improving productivity and ensuring deadlines are met.

Overall, the dynamic content aging system offers numerous benefits, including enhanced task management, improved deadline tracking, and increased user engagement through customization. By providing a novel approach to visualizing content age, various embodiments of the present disclosure can address a significant gap in existing document editing applications, offering a unique solution that is both innovative and practical.

For example, in the document editing application interface illustrating the dynamic content aging features of embodiments of the disclosure, new content entry represents the initial stage of content input by a user. This new content is displayed with an initial font style and color, which provides the baseline from which dynamic aging transformations occur.

The document editing application interface is configured to facilitate the entry and modification of content within a document. This interface is integral to some embodiments of the present disclosure as it provides the platform through which users can input new data, which is then subject to the dynamic aging process. The interface is designed to be compatible with various document editing applications, such as spreadsheets and word processors, thereby ensuring broad applicability and ease of integration into existing systems.

The new content entry is the point at which the system detects the insertion of new data into the document. This detection triggers the dynamic aging process. Upon detection, the system assigns a timestamp to the content, which serves as the reference point for subsequent visual transformations. This timestamping mechanism is essential for tracking the age of the content and ensuring that the visual cues accurately reflect the time elapsed since entry.

Content with initial font style and color is displayed in a specified manner upon entry. This initial presentation is typically in a default font style and color, such as a normal font with a red color. The choice of initial style and color is significant as it provides a clear visual distinction from older content, thereby aiding users in identifying new entries quickly. This initial state serves as the starting point for the dynamic transformations that occur over time.

The dynamic aging system can be configured to automatically modify the font style and/or color of the content over time according to predefined rules. These modifications serve as visual indicators of the content's age, providing users with intuitive cues to assess the recency of information. For instance, the system may alter the font orientation from upright to slanted to sideways as time progresses, or change the font color from red to orange to green. These transformations are designed to be gradual and customizable, allowing users to tailor the visual cues to their preferences and needs.

The tracking module within the system is responsible for monitoring the time elapsed since content entry. This module logs the entry time of each content input and calculates the elapsed time to determine the appropriate visual transformation. The tracking module ensures that the system accurately reflects the age of the content, thereby enhancing the user's ability to manage tasks and deadlines effectively.

The presentation module is configured to alter the appearance of the content based on the time elapsed. This module provides the visual cues that indicate the content's age, such as changes in font style, color, and size. The presentation module is also designed to allow user customization, enabling users to select different font styles, colors, and time intervals for content aging. This customization feature enhances the system's flexibility and adaptability to different user preferences and document types.

Various embodiments of the present disclosure can be implemented in various document editing applications, including but not limited to Microsoft Excel™ and Microsoft Word™. This broad applicability ensures that the system can be integrated into a wide range of environments, providing users with a consistent and reliable method for tracking content age across different platforms. The system's ability to dynamically indicate content age offers significant advantages in task management and deadline tracking, making it a valuable tool for users in various professional and personal contexts.

Potential applications can include project management, academic research, and collaborative work environments where tracking the age of content is critical. The system's visual cues can help users prioritize tasks, manage deadlines, and organize information more effectively. By providing a clear and intuitive method for assessing content age, productivity and efficiency in document editing tasks can be greatly improved.

The dynamic content aging system for document editing applications offers a novel and effective solution for indicating the age of content within documents. By providing visual transformations based on time elapsed since entry, the system aids users in managing tasks and deadlines more effectively, and provides flexibility, customization options, and broad applicability, making it a valuable addition to modern document editing tools.

The dynamic transformation of font orientation over time provides a visual representation of content aging within a document editing application. The figure demonstrates the progression of font orientation from upright to slanted to sideways, correlating with the age of the content. The upright font orientation can be the initial state of the content on Day 1. This orientation serves as the default presentation style when new content is entered into the document, providing a clear and standard appearance for immediate recognition.

In a slightly slanted font orientation, representing the content's appearance on Day 2, this subtle change in orientation serves as an early visual cue to the user, indicating that the content is no longer new but still relatively recent. The slanted orientation is designed to be noticeable yet not disruptive, allowing users to quickly identify content that may require attention or follow-up.

In a more slanted font orientation, which occurs on Day 3, this further alteration in font orientation signifies that the content is aging and may need to be reviewed or updated. The increased slant provides a stronger visual indication of the content's age, prompting users to prioritize tasks associated with this content.

In a sideways font orientation, indicating older content, this orientation is used for content that has surpassed a certain age threshold, signaling to the user that the content is significantly aged and may require immediate action or archiving. The sideways orientation is a clear and distinct visual cue, ensuring that users can easily differentiate between new and old content within their documents.

Some embodiments of the present disclosure described herein provide a method for dynamically indicating the age of content within a document editing application. This method involves detecting the entry of new content and initially displaying it in a specified font style and color. Over time, the system automatically modifies the font style and/or color according to predefined rules, thereby providing a visual indication of the content's age. This dynamic transformation is achieved through changes in font orientation, as depicted in FIG. 3, and can also include modifications in font color and size.

The system can include a tracking module configured to monitor the time elapsed since content entry and a presentation module that alters the appearance of the content based on the elapsed time. This provides users with visual cues regarding the content's age, aiding in task management and deadline tracking. The presentation module is further configured to allow user customization of font styles, colors, and time intervals for content aging, enhancing the system's adaptability to different user preferences and requirements.

Potential applications can include use in document editing applications such as Microsoft Excel™ and Microsoft Word™, where users frequently manage large volumes of data and text. By providing visual cues for content aging, the system can improve efficiency in task management, reduce the likelihood of missed deadlines, and enhance overall document organization. The benefits of some embodiments of the present disclosure can include increased user awareness of content age, improved prioritization of tasks, and enhanced ability to track and manage deadlines effectively.

In some other embodiments, the system can incorporate additional visual transformations, such as gradually shrinking the font size over time to simulate a “falling asleep” effect or fading the color intensity to indicate content aging. These variations provide further customization options for users, allowing them to tailor the visual cues to their specific needs and preferences. The system's ability to dynamically transform content appearance based on time elapsed since entry distinguishes it from existing technologies, offering a novel solution for personal task management and deadline tracking.

Various embodiments of the present disclosure provide a document editing interface where users can seamlessly input and manage content. The interface highlights new entries with a distinct font style and color, ensuring that users can easily identify recent additions.

The system can employ a dynamic aging process that visually transforms content over time. This process is initiated upon the detection of new content, which is initially displayed in a predetermined style and color.

The document interface can be designed to enhance user interaction by offering intuitive navigation and a comprehensive suite of editing tools. Users can customize the appearance of new entries to suit their preferences.

The system can provide visual cues such as changing font orientation and color to indicate the age of content. These cues help users prioritize tasks and manage deadlines effectively.

Users can personalize the system by selecting different font styles, colors, and time intervals for content aging. This flexibility ensures that the system can adapt to various document types and user needs. In some embodiments, such personalization is achieved automatically without user input, such as based on user profiles, AI-learned user habits, etc.

In collaborative environments, the system distinguishes entries made by different users using unique visual identifiers. This feature enhances communication and coordination among team members.

The system can include a tracking module that records timestamps of content entries and a presentation module that alters the appearance of content based on elapsed time. This architecture ensures accurate and timely visual feedback.

Some embodiments of the present disclosure can be applied in various settings, such as educational institutions for tracking student submissions, corporate environments for project management, and personal use for organizing tasks.

By providing dynamic visual cues, the system improves productivity and efficiency, reduces the likelihood of missed deadlines, and supports collaborative efforts through clear visual differentiation of user contributions.

The system can also modify font size over time or incorporate additional visual effects such as fading colors to further enhance content aging indications.

These variations can bring versatility and adaptability into content presentation editing, making it suitable for a wide range of applications and user preferences.

The method and system for automatically altering the presentation of content in digital documents based on spatiotemporal parameters, such as time of input, locations, and user identifications can be integrated with artificial intelligence (AI) agents. While AI agents typically provide streamlined reminders for users based on a timeline, various embodiments of the present disclosure present an intuitive, 2D, 3D, or even 4D presentation of documents to users.

Digital documents, such as spreadsheets and word processing documents, are widely used for collaborative work. However, existing systems lack dynamic presentation features that reflect the age, origin, or context of the content. For example, in collaborative environments, it can be challenging to differentiate between inputs from multiple users or to visualize the “freshness” of content. Current systems rely on static formatting, which does not adapt to the evolving context of the document.

Various embodiments of the present disclosure provide a method and system for dynamically altering the presentation of content in digital documents based on spatiotemporal parameters, such as time of input, locations, and user identifications/profiles. The methods and systems can automatically adjust visual and audio elements of the content, such as colors, fonts, shades, and tones, to reflect the age (e.g., “freshness”), origin, and context of the content. This dynamic presentation enhances user experience, improves readability, and facilitates collaboration in digital documents.

Some embodiments of the present disclosure provide a software-based system integrated into digital document applications, such as word processors and spreadsheets. The system receives content input from one or more users and dynamically alters its presentation based on spatiotemporal parameters, including time of input, location, and user identification.

For example, a method provided can include the following steps.

Step 1: The system receives content input from a user.

Step 2: The system records spatiotemporal parameters, such as the time of input, user identification, and location.

Step 3: The system automatically alters the presentation of the content based on the recorded parameters.

Step 4: The altered presentation is displayed in the digital document.

The system alters visual elements such as colors, shades, and fonts based on the time elapsed since the content was inputted.

Example 1: Colors gradually change from red to orange, to green, and then to black over time. Example 2: Fonts rotate sideways over time, simulating a “falling asleep” effect. Example 3: Shades gradually fade, becoming lighter over time.

In collaborative documents, the system differentiates content from different users or locations by assigning unique fonts and colors. These styles further evolve to indicate the age of the content.

Some embodiments of the present disclosure also provide audio presentation alteration.

The system alters audio elements, such as tone, based on the time elapsed since the content was inputted.

In an example, the audio presentation gradually adopts a “sleepy” tone over time.

In a spreadsheet, numerical data inputted at different times is displayed in varying colors to indicate its age.

In a collaborative word processing document, text from different users is displayed in unique fonts and colors, which gradually change to reflect the age of the content.

A method and system for dynamically altering the presentation of content in digital documents based on spatiotemporal parameters, such as time of input, location, and user identification. The invention automatically adjusts visual and audio elements, such as colors, fonts, shades, and tones, to reflect the age, origin, and context of the content. This dynamic presentation enhances user experience, improves readability, and facilitates collaboration in digital documents.

Referring back to FIG. 1 for an illustration of a document editing application interface, showcasing the initial content entry with a default font and color, the document interface 100 provides a visual representation of the environment where users input data. The initial content entry 102 is depicted as the text or data that a user inputs into the document. This content is initially displayed in a default font style and color 104, which serves as the baseline presentation for newly entered data. This initial state is crucial as it sets the stage for the dynamic changes that occur over time, as described in the invention.

The document interface 100 is designed to facilitate user interaction with digital documents, such as spreadsheets or word processing files. This interface is configured to detect when new content is entered by a user. Upon detection, the system assigns a timestamp to the content, marking the beginning of its lifecycle within the document. This timestamp is a critical component, as it triggers the subsequent visual transformations that indicate the age of the content.

The initial content entry 102 is configured to be displayed in a specified font style and color, as outlined in the claims. This initial presentation can be customized according to user preferences or system defaults. The choice of font style and color is not arbitrary; it is strategically selected to provide a clear contrast with the subsequent changes that occur over time. This contrast is essential for users to easily distinguish between new and older entries, thereby enhancing task management and deadline tracking.

The default font style and color 104 serve as the starting point for the dynamic visual transformations that characterize this invention. As time elapses, the system automatically alters the presentation of the content based on predefined rules. These alterations can include changes in font orientation, color, and shade, as well as other visual attributes. For example, the font may start as upright and gradually become slanted or sideways, simulating a ‘falling asleep’ effect. Similarly, the color may transition from red to orange to green, and eventually to black, providing a visual timeline of the content's age.

The method for presentation of content in a digital document, as described in the claims, involves automatically altering the presentation based on spatiotemporal parameters of the content inputted by one or more users. This method is applicable to various types of digital documents, including spreadsheets and word processing documents. The visual presentation comprises at least one of colors, shades, or fonts, which are modified over time to indicate the age of the content.

The spatiotemporal parameters include the time of input of the content, which is a factor in determining the rate and nature of the visual transformations. The system is configured to track the elapsed time since the content was entered and to apply the corresponding visual changes at predetermined intervals. This feature allows users to quickly assess the recency of the content, aiding in prioritization and decision-making processes.

The system's ability to customize the visual presentation based on user preferences is another significant advantage. Users can select different color schemes, font styles, and time intervals for content aging, allowing for a personalized experience that aligns with individual needs and workflows. This customization enhances the system's flexibility and applicability across different user scenarios and document types.

Potential applications of this invention extend beyond individual task management. In collaborative environments, the system can differentiate inputs from different users by applying unique visual transformations based on user identification. This feature not only indicates the age of the content but also provides insights into its origin, facilitating better collaboration and accountability among team members.

The benefits of this dynamic content aging system are manifold. It provides a clear visual indication of the age of document entries, reducing the cognitive load on users and minimizing the risk of overlooking important deadlines or tasks. By automating the tracking and presentation of content age, the system enhances productivity and efficiency in document management, making it a valuable tool for both individual and collaborative use cases.

In an example, three distinct stages of font orientation are provided: upright font orientation, slightly slanted font orientation, and sideways font orientation. These stages represent the progressive changes in font orientation that occur as time elapses from the initial entry of content into a document.

The upright font orientation represents the initial state of the content when it is first entered into the document. At this stage, the font is displayed in a normal, upright position, which serves as the default presentation for newly inputted content. This initial state is crucial as it provides a clear baseline from which subsequent changes can be measured. The upright orientation can be where fonts are normal and upright at the time of input of the content.

As time progresses, the system is configured to automatically alter the font orientation to a slightly slanted position, as depicted by the slightly slanted font orientation. This transformation occurs after a predefined period, such as one day, and serves as a visual cue to the user that the content is no longer recent. The slanting of the font is a subtle yet effective way to indicate the passage of time without overwhelming the user with drastic changes. This stage aligns with the inventive concept of providing a gradual visual transformation to indicate content aging.

Further time elapse results in the font orientation transitioning to a sideways position, as shown by the sideways font orientation. This stage represents a more pronounced indication of the content's age, suggesting that the content is significantly older. The sideways orientation is designed to mimic the appearance of text “falling asleep,” providing a clear and intuitive visual metaphor for aging content. This transformation where fonts are automatically rotated sideways over time as if falling asleep.

The method of altering font orientation over time offers several advantages. It provides users with an immediate visual indication of the age of content, aiding in task management and deadline tracking. By visually distinguishing older content, users can prioritize tasks more effectively and avoid overlooking important deadlines. Additionally, this method can be customized to suit individual user preferences, allowing for different time intervals and font styles to be selected based on personal or organizational needs.

In some applications, this system can be implemented in various document editing applications, including spreadsheets and word processors. It is particularly beneficial in collaborative environments where multiple users input and modify content over time. By providing a visual representation of content age, the system enhances communication and coordination among users, ensuring that all parties are aware of the most recent updates and changes.

Overall, the method of dynamically altering font orientation based on time elapsed since content entry represents a novel approach to content management within digital documents. It addresses the issue of tracking content age and provides a user-friendly solution that enhances productivity and organization.

The progression of font color changes over time provides a visual representation of how content within a document editing application can dynamically indicate its age. In an example, the font color of text entries transitions through a series of colors as time elapses.

For example, a red font color can represent the initial state of the content upon entry. When a user inputs new data into a document, such as a spreadsheet or word processor, the content is initially displayed in a red font. This initial color serves as a visual cue to the user that the content is newly entered and requires attention or action. The choice of red can be intentional, as it is a color often associated with urgency or importance, prompting the user to prioritize these entries.

As time progresses, the system is configured to automatically alter the font color from red to orange, as depicted by the orange font color. This change typically occurs after a predefined time interval, such as one day. The transition to orange indicates that the content is no longer new but still relatively recent. This gradual change helps users track the age of their entries without needing to manually check timestamps or other metadata.

Further along the timeline, the font color shifts to green, as shown by the green font color. This stage signifies that the content has aged further, perhaps reaching a few days since its initial entry. Green is often associated with stability and completion, suggesting to the user that while the content is still relevant, it may not require immediate attention. This stage helps users differentiate between tasks that are still pending and those that have been addressed or are less urgent.

In a final step for example, the font color transitions to black, represented by the black font color. This stage indicates that the content is older and may no longer be of immediate concern. The use of black, a neutral and standard color for text, suggests that the entry has reached a stable state where it can be archived or reviewed at the user's convenience. This final color change serves as a clear visual indicator that the content has completed its lifecycle in terms of urgency and relevance.

The method can include the gradual nature of these color changes, which occur over the time elapsed since the content's entry. This dynamic transformation provides users with an intuitive way to manage and prioritize their tasks within digital documents. By visually distinguishing content based on age, the system aids in effective task management and deadline tracking, reducing the cognitive load on users and enhancing productivity.

The potential applications can span various document editing platforms, including spreadsheets and word processors. It can be particularly beneficial in collaborative environments where multiple users contribute to a document, as it provides a clear visual history of when content was added or modified. This feature can also be customized to suit individual user preferences, allowing for different color schemes, font styles, and time intervals, thereby offering flexibility and adaptability to diverse user needs.

The novel approach to document management can leverage visual cues to indicate the age of content. This system not only enhances user experience by simplifying task prioritization but also improves overall document organization and efficiency. The ability to customize the visual transformation further adds to its appeal, making it a versatile tool for both individual and collaborative document editing scenarios.

The process flow of the system can be configured to track the time elapsed since content entry and modify the presentation of the content accordingly. The flow can include content entry detection, time elapsed tracking, and presentation modification rules. Each of these components plays a role in the dynamic content aging system, which is integrated into document editing applications such as spreadsheets and word processors.

The content entry detection module is configured to identify when new content is entered into a document. This module serves as the initial trigger for the system, ensuring that any new data input by a user is recognized and subsequently monitored. This detection is crucial for initiating the time tracking process, as it marks the starting point from which the age of the content will be calculated. The detection can be implemented through various methods, such as monitoring keystrokes or changes in the document's data structure.

Once the content entry is detected, the time elapsed tracking module begins to monitor the duration since the content was first entered. This module is responsible for maintaining an accurate record of the time that has passed, which is essential for determining when and how the content's presentation should be modified. The tracking can be achieved through system clocks or timers that are synchronized with the document editing application, ensuring precise measurement of time intervals.

The presentation modification rules module is tasked with altering the visual presentation of the content based on the time elapsed. This module applies predefined rules that dictate how the content's appearance should change over time. For example, the rules may specify that the font color changes from red to orange to green as days pass, or that the font orientation shifts from upright to slanted to become sideways. These modifications provide users with visual cues about the age of the content, aiding in task management and deadline tracking.

The system's ability to dynamically alter content presentation based on time elapsed offers several advantages. It enhances user awareness of content age, allowing for better prioritization of tasks and deadlines. Additionally, the system can be customized to suit individual user preferences, offering flexibility in terms of color schemes, font styles, and time intervals. This customization ensures that the system can be tailored to meet the specific needs of different users and applications.

Potential applications can extend beyond traditional document editing. It can be integrated into collaborative platforms where multiple users contribute to a single document, providing a clear indication of when each user made their contributions. This feature can improve collaboration by helping team members understand the timeline of document edits and updates, thereby facilitating more efficient project management.

The approach to content management distinguishes it from existing technologies that focus primarily on collaborative editing and comment management. By providing a dynamic visual transformation of content based on time elapsed, this system addresses a previously unmet need for visual aging of document content, thereby enhancing personal task management and deadline tracking.

Overall, the dynamic content aging system offers a robust solution for managing document content in a way that is both intuitive and effective. Its integration into existing document editing applications can significantly improve user experience by providing clear, visual indicators of content age, ultimately leading to better organization and management of information.

A collaborative document interface can be designed to facilitate the differentiation of user inputs through distinct font styles and colors. This interface is particularly beneficial in environments where multiple users contribute to a single document, such as in collaborative spreadsheets or word processing documents. The collaborative document interface can be configured to visually distinguish inputs from different users, thereby enhancing the clarity and organization of the document.

User A input and user B input are examples of how the system differentiates contributions from different users. Each input is presented in a unique font style and color, as indicated by the distinct font styles and colors. This differentiation is achieved by automatically determining the presentation of texts based on user identification or location, as described in the claims. Such a feature is particularly useful in collaborative settings, where the origin of each entry is automatically tracked, thereby improving accountability and traceability.

The distinct font styles and colors not only serve to differentiate user inputs but also provide a dynamic indication of the content's age. As time progresses, the fonts and colors of the inputs gradually change, offering a visual cue regarding the age of the content. This feature is aligned with the method described in the claims, where fonts and colors are configured to change over time to indicate the age of the content. This dynamic transformation aids users in quickly identifying recent versus older entries, thus enhancing task management and deadline tracking.

The method for presentation of content in a digital document, involves automatically altering the presentation based on spatiotemporal parameters of the content inputted by one or more users. This method is applicable to various digital documents, including spreadsheets and word processing documents, where the visual presentation comprises elements such as colors, shades, or fonts. The system is configured to change these elements over time, providing a visual representation of the content's age and facilitating better management of tasks and deadlines.

In one embodiment, the method involves the gradual fading of shades over time elapsed since the content was inputted. This fading effect serves as a visual indicator of the content's age, allowing users to easily discern newer entries from older ones. The fading process is automated and follows predefined rules that can be customized according to user preferences or system defaults. This feature is particularly useful in collaborative environments where multiple users contribute to a document, as it helps maintain clarity and organization.

The system can be implemented in various digital document formats, including spreadsheets and word processing documents. Upon the initial input of content, the system displays the content in a specified font style and color. As time progresses, the system automatically adjusts the font style and color according to a set of predefined rules. For example, the font color may transition from red to orange, then to green, and finally to black as time elapses. This color transition provides a clear visual representation of the content's age, aiding users in task management and deadline tracking.

Another embodiment of the disclosure involves altering the orientation of fonts over time. Initially, the fonts are displayed in a normal, upright position. As time passes, the fonts gradually rotate to a slanted position, eventually appearing sideways as if they are “falling asleep.” This visual transformation not only indicates the age of the content but also adds an element of visual interest to the document, making it easier for users to engage with and interpret the information.

The system also supports the customization of visual cues based on user preferences. Users can select different color schemes, font styles, and time intervals for content aging, allowing for a personalized document experience. This flexibility ensures that the system can be adapted to suit the specific needs and preferences of individual users or organizations.

In addition to visual presentations, the system can also incorporate audio presentations. Over time, the audio associated with a content entry can transition to a “sleepy” tone, providing an auditory cue that complements the visual changes. This feature can be particularly beneficial for users who rely on auditory signals for task management and organization.

By providing clear visual and auditory cues about the age of content entries, the system enhances task management and deadline tracking, reducing the likelihood of missed deadlines or overlooked tasks. Furthermore, the system's ability to differentiate inputs from different users based on location or user identification adds an additional layer of organization and clarity to collaborative projects.

In one embodiment, the method involves the automatic alteration of visual presentations, such as colors, shades, or fonts, based on the time elapsed since the content was inputted by one or more users. This feature is particularly useful in collaborative environments where multiple users contribute to a single document. By tracking the time of input, the system can provide a visual representation of the content's age, allowing users to quickly identify new and old entries.

The method further includes a specific implementation where the colors of the content change gradually over time. Initially, the content may be displayed in a vibrant color such as red, which then transitions to orange, green, and eventually black as more time elapses. This color transition serves as a visual indicator of the content's age, helping users prioritize tasks based on their recency.

Another embodiment of the invention focuses on the modification of font styles over time. When content is first entered, it is displayed in a normal, upright font. As time progresses, the font orientation changes, becoming slightly slanted on the second day and more slanted by the third day. Eventually, the font may appear sideways, resembling a “sleeping” state, which visually signifies that the content is older.

A system includes a tracking module and a presentation module. The tracking module is configured to monitor the time elapsed since content entry, while the presentation module is responsible for altering the appearance of the content based on the elapsed time. This system provides users with visual cues regarding the age of content, thereby facilitating efficient task management and deadline tracking.

In addition to visual transformations, the system allows for user customization. Users can select different color schemes, font styles, and time intervals for content aging, tailoring the system to their specific preferences and needs. This flexibility enhances the user experience and ensures that the system can be adapted to various document editing applications.

By offering a unique solution for visual aging of content, the invention aids in personal task management and deadline tracking, setting it apart from existing technologies.

Potential applications of this invention include any digital document editing environment where tracking the age of content is beneficial. This could range from personal task lists and project management spreadsheets to collaborative documents in corporate settings. The system's ability to provide immediate visual feedback on content age can significantly improve organizational efficiency and task prioritization.

In another embodiment, the system may alter the shades of the content over time. Initially, the shades may be bold and prominent, but as time passes, they gradually fade, becoming lighter. This fading effect provides an additional visual indication of the content's age, helping users to quickly identify older entries that may require attention or action.

An audio presentation method can also be provided, where the presentation of the content includes an audio component. Over time, the audio presentation may transition into a “sleepy tone,” providing an auditory cue to the user regarding the age of the content. This audio feature can be particularly useful in environments where visual cues may not be as effective or accessible.

The system is designed to be highly customizable, allowing users to select initial font styles and colors at the time of content input. As time elapses, the system automatically adjusts these attributes, providing a dynamic and personalized user experience. This customization feature ensures that the system can adapt to various user preferences and document types, making it versatile and widely applicable.

In collaborative environments, the system can differentiate inputs from different users by utilizing spatiotemporal parameters such as location and user identification. This differentiation is achieved by presenting texts in fonts and colors that are automatically determined based on these parameters. As the content ages, the fonts and colors further change, providing a clear indication of both the age and origin of the content.

The system's ability to customize visual and auditory cues based on user preferences further enhances its utility. Users can select different color schemes, font styles, and time intervals for content aging, allowing the system to be tailored to individual needs and preferences. This customization ensures that the system remains flexible and adaptable to various user requirements and document types.

It can be integrated into project management tools, educational platforms, and any digital environment where tracking the age and origin of content is crucial. The dynamic content aging system not only improves task management and deadline tracking but also enhances user engagement by providing intuitive and interactive feedback mechanisms.

The system can be customized to suit different user preferences, allowing for various color schemes, font styles, and time intervals for content aging. This flexibility ensures that the system can be adapted to different user needs and preferences, enhancing its applicability across various document editing applications.

The advent of collaborative digital documents has revolutionized how users interact with text, spreadsheets, and other forms of digital content. However, the static nature of content presentation in these documents often fails to reflect the dynamic context in which they are created and edited. Embodiments of the present disclosure address this gap by introducing a system that dynamically alters content presentation based on spatiotemporal parameters such as time of input, location, and user identification.

By automatically altering the presentation of content based on spatiotemporal parameters, and adjusting visual elements (colors, fonts, shades) and audio elements (tones) to reflect the age, origin, and context of the content, user experience can be enhanced, with improved readability, and collaboration by providing dynamic, context-aware visual and auditory cues.

In some embodiments of dynamic content presentation based on temporal parameters, methods and apparatuses for temporal formatting of digital content are provided.

The system modifies the formatting of digital content over time to indicate changes or updates. For example, newly added content might appear highlighted and gradually return to standard formatting as it ages.

The system uses temporal parameters to alter content presentation, focusing on highlighting changes rather than a comprehensive spatiotemporal approach according to some other embodiments of the present disclosure.

In a collaborative editing with user-specific formatting example, systems and methods are provided for collaborative document editing with user identification or profiles.

The collaborative editing platform where contributions from different users are displayed in distinct styles or colors can facilitate easy identification of each user's input.

In an example of a location-based content modification, a method for location-based content customization is provided, including techniques for altering digital content presentation based on the user's geographical location. For instance, displaying region-specific information or adjusting language settings.

The location parameter can be part of, or example of, the spatiotemporal data. In some embodiments, the system customizes content based on location rather than dynamically altering existing content's presentation over time.

In an example of visual indicators for data age in spreadsheets, a method for indicating data freshness in electronic spreadsheets is provided, introducing visual cues, such as color gradients or icons, to indicate the freshness of data within a spreadsheet cell.

In some other embodiments, the dynamic audio alteration can introduce audio elements that change over time (e.g., transitioning to a “sleepy” tone).

The evolution of visual elements over time can involve specific visual transformations (e.g., fonts rotating sideways, colors shifting from red to black) that signify the content's age in an intuitive and engaging manner.

By differentiating inputs from various users and locations and allowing these distinctions to evolve over time, an embodiment of the present disclosure fosters a more interactive and informative collaborative environment.

The continuous and automatic evolution of content presentation as time elapses introduces a temporal dimension that enhances user awareness of content relevance.

Various embodiments of the present disclosure provide a method for the presentation of content in digital documents, where the presentation is automatically altered based on spatiotemporal parameters of the content inputted by one or more users. This method applies to digital documents such as spreadsheets or word processing documents. The presentation is primarily visual, comprising elements like colors, shades, or fonts. These visual elements are dynamically adjusted based on the time of input of the content. For instance, colors may gradually change over time, transitioning from red to orange, to green, and then to black, indicating the passage of time since the content was entered. Fonts initially appear normal and upright but are automatically rotated sideways over time, resembling a ‘falling asleep’ effect. Shades also gradually fade, becoming lighter as time elapses. In addition to visual presentations, the method includes audio presentations where the tone becomes sleepier over time.

The disclosure also addresses collaborative documents by allowing differentiation of inputs from different users and/or locations. Texts are presented in fonts and colors automatically determined based on user identification or location, and these attributes gradually change to indicate the age of the content. This system not only enhances the visual and auditory experience of document management but also aids in task management and deadline reminders, integrating seamlessly with existing document formats and ensuring accessibility for users with visual impairments.

The disclosure's dynamic presentation method is particularly advantageous in collaborative environments, where multiple users contribute to a single document. By assigning unique font styles or colors to different authors, the system facilitates easy identification of contributions, enhancing collaboration and accountability. This feature can be particularly beneficial in project management scenarios, where tracking individual contributions and task progress is crucial.

Moreover, the disclosure's compatibility with existing document formats and software ensures seamless integration into current workflows. Users can customize the time intervals and visual changes to suit their specific needs, allowing for a tailored experience that aligns with individual or organizational priorities. This flexibility makes the disclosure suitable for a wide range of applications, from personal task management to complex project coordination.

In addition to its visual capabilities, the system can be integrated with notification alerts, providing users with timely reminders of approaching deadlines based on the age of the content. This integration further enhances the system's utility as a task management tool, streamlining workflow and prioritization by allowing users to focus on tasks that require immediate attention.

The method for presentation alteration offers several advantages and potential applications. By providing a visually intuitive method for tracking the age of document entries, the system enhances productivity and organization in digital document management. Users can quickly scan documents to identify tasks that require immediate attention, streamlining workflow and prioritization. Additionally, the system's ability to differentiate authorship through unique visual attributes fosters collaboration and accountability among team members.

Moreover, the system is designed to be compatible with existing document formats and software, ensuring easy integration into current workflows. Accessibility features, such as adjustable contrast and font size, are also included to accommodate users with visual impairments, broadening the system's applicability and usability.

The method for presentation alteration based on spatiotemporal parameters provides a novel approach to managing digital documents. By dynamically altering the visual presentation of content over time, the system offers a clear and intuitive indication of content age and authorship, enhancing user interaction and collaboration in various digital environments.

The disclosure described herein provides a method for enhancing user interaction with digital documents by dynamically altering the visual presentation of text based on the time elapsed since its initial entry. This method is particularly applicable to digital documents such as spreadsheets or word processing documents, as referenced in the claims. The system automatically alters the presentation of text based on spatiotemporal parameters, allowing users to easily track the age of content and identify authorship in collaborative environments.

The disclosure also allows for customizable time thresholds, enabling users to tailor the system to their specific needs. For instance, users can set shorter intervals for high-priority projects or longer intervals for less urgent tasks. This customization enhances the system's flexibility and applicability across various use cases.

In collaborative documents, the system assigns unique visual attributes to different authors, such as distinct font styles or colors. This feature facilitates easy identification of which team member made specific edits, thereby enhancing collaboration and accountability. The integration with task management further streamlines workflow by allowing users to quickly scan a document and identify tasks that require immediate attention based on the visual state of the text.

The system's compatibility and accessibility features ensure easy integration with existing document formats and software. Accessibility features such as adjustable contrast and font size accommodate users with visual impairments, making the system inclusive and user-friendly.

The disclosure provides a visually intuitive method for tracking the age of document entries and identifying authorship, enhancing productivity, organization, and collaboration in digital document management. It offers a distinct advantage by focusing on time-based visual transformations rather than content reflow or comment navigation, thereby addressing a critical need in the management of digital documents.

The system's ability to customize visual cues and time thresholds allows users to tailor the document presentation to their specific needs. This customization is particularly beneficial in task management, where users can set shorter intervals for high-priority tasks, ensuring that important deadlines are not overlooked. The integration with notification systems further enhances this capability, alerting users of approaching deadlines based on the age of the content.

The network-based collaborative editing system offers advantages in digital document management. By providing a visually intuitive method for tracking content age and identifying authorship, the system enhances productivity, organization, and collaboration. Its compatibility with existing document formats and software ensures easy integration, while accessibility features accommodate users with visual impairments, making it a versatile solution for a wide range of applications.

The present disclosure introduces a method and system for dynamically altering the presentation of content in digital documents, such as spreadsheets and word processing documents, based on spatiotemporal parameters. This method is particularly advantageous in environments where tracking the age of content and identifying authorship is crucial, thereby enhancing productivity and collaboration.

The method involves automatically modifying the presentation of content in a digital document over time. This modification includes changes in visual attributes such as colors, shades, and fonts, or an audio presentation providing auditory cues of content age. Initially, text may appear in a standard, upright font and vibrant color, such as red. As time progresses, the font style evolves to reflect the passage of time, becoming slightly italicized after the first day, more slanted by the second day, and eventually appearing horizontally oriented to indicate older content. Concurrently, the color transitions through a spectrum-red to orange, then to green, and finally to a neutral color like black. This dynamic transformation provides a visual timeline, aiding users in quickly distinguishing between new and old entries.

Users have the flexibility to customize time intervals and corresponding visual changes to suit specific needs, such as setting shorter intervals for high-priority tasks. In collaborative documents, unique font styles or colors can be assigned to different authors, allowing users to easily identify contributions from team members, thus enhancing collaboration and accountability.

The system's integration with task management tools further streamlines workflow, as evolving text presentation allows users to quickly scan a document and identify tasks requiring immediate attention. Notification alerts can also be integrated to remind users of approaching deadlines based on content age.

Designed for compatibility with existing document formats and software, the system ensures easy integration into current workflows. Accessibility features such as adjustable contrast and font size accommodate users with visual impairments, making the system inclusive and user-friendly.

By providing a visually and audibly intuitive method for tracking the age of document entries and identifying authorship, this disclosure enhances productivity, organization, and collaboration in digital document management. The focus on time-based visual transformations offers a distinct advantage over prior art, which often emphasizes content reflow or comment navigation, thereby improving user interaction with digital documents.

In an example, when a user first types in to some new content into a document like an Excel table or a word document, the user often forgets when the typing happened. The methods and systems provide a new document format, for example in an Excel table entry when you first typing in some entry. The characters and the fonts are a first specified type. For example, they can be normal font, standing up or read. At that time elapses, the content would gradually change shapes, colors or other presentations. For example, when after a first day the fonts become slightly slanted. After the second day, the fonts become more slanted. After a long period of time, the fonts become sideways as if they are sleeping. In another embodiment, after a first day, the font color fades a little bit in the second day. And found color fades even more. In the third day, the font color fades even more in yet another variation or embodiment. In the first day the fonts are normal. In the second day the fonts change the color from, for example, from red to orange. In the third day, the font color changed to from orange to green in the after a certain preset time. After a certain threshold, the fonts changed to black for example that way when the user view. The Excel table. They would immediately recognize what's new and what's old when they typed them to help them remind them of important deadlines and due dates and the to do list for the next few days.

By dynamically altering fonts and colors over time, users can easily identify new content and track changes within documents. This system is particularly useful for applications such as Excel tables, Word documents, and other text-based formats.

In today's fast-paced digital environment, individuals often work with large volumes of information across various documents. Keeping track of updates, deadlines, and important tasks can be challenging. Existing document formats lack features that visually highlight new content or changes over time. The proposed invention addresses this limitation by introducing a dynamic font and color variation system.

The dynamic font and color variation system can involve the following steps.

### Initial Font and Color Specification.

When a user types new content into a document (e.g., an Excel table or Word document), the characters initially appear in a specified font and color (e.g., normal font, bold, red).

### Gradual Alterations.

Over time, the font and color gradually change based on predefined intervals (e.g., daily).

For example, after the first day, the font becomes slightly slanted.

After the second day, the font slant increases.

After an extended period, the font becomes sideways, resembling a “sleeping” font.

Alternatively, font color fades incrementally over days.

### Thresholds and Transitions.

After a certain preset time (e.g., a week), the font reaches a threshold (e.g., fully slanted or faded).

At this point, the font transitions to a different state (e.g., black).

Users can immediately recognize what's new (based on font variations) and what's old.

### Application to Deadlines and To-Do Lists.

Users can apply this system to track deadlines and due dates.

For instance, new entries related to upcoming deadlines appear in distinct fonts/colors.

As deadlines approach, the font/color changes serve as visual reminders.

Users can quickly identify urgent tasks and prioritize their to-do lists.

When a user first types in to some new content into a document like an Excel table or a word document, the user often forgets when the typing happened. The methods and systems provide a new document format, for example in an Excel table entry when you first typing in some entry. The characters and the fonts are a first specified type. For example, they can be normal font, standing up or read. At that time elapses, the content would gradually change shapes, colors or other presentations. For example, when after a first day the fonts become slightly slanted. After the second day, the fonts become more slanted. After a long period of time, the fonts become sideways as if they are sleeping. In another embodiment, after a first day, the font color fades a little bit in the second day. And found color fades even more. In the third day, the font color fades even more in yet another variation or embodiment. In the first day the fonts are normal. In the second day the fonts change the color from, for example, from red to orange. In the third day, the font color changed to from orange to green in the after a certain preset time. After a certain threshold, the fonts changed to black for example that way when the user view. The Excel table. They would immediately recognize what's new and what's old when they typed them to help them remind them of important deadlines and due dates and the to do list for the next few days.

In one embodiment, when a user first enters text into a digital document (e.g., an Excel table or Word document), the text is displayed in a specified initial font style (e.g., normal, upright). As time elapses, the font style gradually changes. For example:

After one day, the font becomes slightly slanted.

After two days, the font becomes more slanted.

After a longer period, the font becomes sideways, as if “sleeping.”

In another embodiment, the font color gradually fades over time.

On the first day, the font color is normal.

On the second day, the font color fades slightly.

On the third day, the font color fades further.

In yet another embodiment, the font color changes over time to indicate the age of the content:

On the first day, the font color is red.

On the second day, the font color changes to orange.

On the third day, the font color changes to green.

After a preset period, the font color changes to black.

These visual cues allow users to quickly identify new and old content, helping them to prioritize tasks and manage deadlines effectively.

Another aspect of the present disclosure relates to an automated system for organizing and delivering educational content to users. Specifically, the system utilizes authority-published structures, such as FAA outlines for pilots, to categorize and present relevant video and textual lessons. Users can access the content sequentially, following a structured learning path. The system also handles royalty distribution to content creators based on user fees.

Traditional online learning platforms often lack a standardized structure for organizing educational content. Users may struggle to find relevant materials or follow a coherent learning path. Additionally, content creators face challenges in monetizing their work effectively.

The automated system described herein addresses these issues by providing an organized and efficient way to deliver educational content. Key features include:

### Content Categorization:

The system automatically categorizes educational content (videos, articles, etc.) based on established authority outlines (e.g., FAA guidelines for pilot training).

Each lesson is tagged with relevant topics (e.g., “Takeoff Procedures,” “Navigation,” “Emergency Landings,” etc.).

### Structured Learning Paths:

Users select their learning objectives (e.g., obtaining a pilot's license).

The system presents a sequential learning path, guiding users through relevant lessons.

Users can view content in a logical order (e.g., “License Lesson 1,” “License Lesson 2,” etc.).

### User-Generated Content:

Users can contribute their own content (e.g., personal experiences, additional resources).

The system integrates user-generated content into the structured learning path.

### Royalty Distribution:

Users pay fees to access the content.

The system automatically distributes royalties to content creators based on usage (views, downloads, etc.).

### Detailed Description

### Content Organization:

The system continuously crawls the internet for relevant educational content.

It analyzes content based on keywords, relevance, and authority sources.

Content is categorized into predefined topics (e.g., “Flight Planning,” “Aircraft Systems,” etc.).

### User Profiles:

Users create profiles, specifying their learning goals (e.g., “Private Pilot License”).

The system tailors content recommendations based on user preferences.

### Structured Learning Paths:

Users select a learning path (e.g., “Pilot License Path”).

The system presents a sequence of lessons, following FAA outlines.

Users can track their progress (e.g., “Completed Lesson 3”).

### User-Generated Content:

Users can submit their own content (e.g., flight logs, study guides).

The system verifies and integrates relevant user-generated content into the learning path.

### Royalty Management:

Content creators register their work with the system.

Users pay subscription fees or per-lesson fees.

The system calculates royalties based on usage and distributes payments to creators.

Efficiency: Users access relevant content without sifting through unrelated materials.

Structured Learning: Users follow a logical progression, ensuring comprehensive understanding.

Monetization: Content creators receive fair compensation for their contributions.

The automated system described herein revolutionizes online education by providing an organized, user-friendly platform. By integrating authority outlines, user-generated content, and royalty management, it enhances the learning experience for aspiring pilots and other learners.

The data entry and presentation methods and systems can be applied to other areas, such as an automated system for organizing and delivering educational content, including the following steps.

Content categorization based on authority outlines.

Structured learning paths for users.

Integration of user-generated content.

Royalty distribution to content creators.

Various embodiments of the present disclosure provide methods and systems for organizing internet content automatically for user. For example, a user wants to learn to fly to get pilots license and once prompted the methods and the system would automatically. Search through all the internet such as YouTube and organize the video and textual lessons based on authority published structure such as FAA outlines for pilots, license and that way. A user, once started can view the license number one, number two, number three, etc. Organized through automatically following the certain outlines, but the content is from the user. Content created from online if so desired. The system and methods automatically distribute the royalties and fees paid by the user to the content creators.

Concerning automatic optical device shutters such as telescope cameras, binoculars, etc. In areas such as in astronomy we take when taking long exposures of the night skies. The satellites such as Star link satellites would cause long strict lines through the long exposure ruining the images being exposed, especially in astronomy sometimes when hours long. Exposure are desired to image or taking spectroscopy of remote celestial extraterrestrial objects such as quasars and galaxies. Databases of all the satellite tracks based on times and locations and the forecast predicted passing through times in front of the telescope and cameras and lenses and automatically either shut down the shutter. Or using a small blocking device to block the satellite from the field of view. For the long exposure, the database will be adjusted or adapted following the location of the telescope. The orientation or the pointing angle of the telescope to a time automatically makes the optical correction or electronic correction to automatically filter out the long streaks of the exposure from the celestial objects such as. Satellites and also airplanes as their lights can ruin the exposure for astronomical research too. Most of the airplanes, especially commercial airliners have fixed the schedules and also they are tractable. There's not a fixed database such as satellites. The software and computer systems or app can automatically track the locations from the airplanes, such as using ADSB signals or FAA dynamic databases and. Likely either temporarily shut down the shutters of the telescope or using blocking device to block them from the field of view, thereby improving optical data integrity and preserving the research for the astronomy. Preserving darker skies.

This diagram shows the main components and functions of the automatic optical device shutter system for satellite and aircraft avoidance. The system consists of four main components: the optical device, the satellite and aircraft tracking database, the optical correction and filtering module, and the shutter and blocking device. The system performs three main functions: satellite and aircraft detection, optical correction and filtering, and shutter and blocking control.

The optical device is a device that captures and records astronomical images, such as a telescope, a camera, or a spectrometer. The device has a lens, a sensor, and a shutter. The device also communicates with the satellite and aircraft tracking database and the optical correction and filtering module.

The satellite and aircraft tracking database is a database that stores and updates the location and trajectory of satellites and aircraft in the sky. The database also communicates with the optical device and the optical correction and filtering module.

The optical correction and filtering module is a module that adjusts the optical device settings or electronically filters out the streaks caused by satellites and aircraft from the astronomical images. The module communicates with the optical device, the satellite and aircraft tracking database, and the shutter and blocking device.

The shutter and blocking device is a device that controls the shutter or employs a blocking device to prevent the exposure of the optical device sensor to the satellites and aircraft. The device communicates with the optical correction and filtering module.

The satellite and aircraft detection function is the process of detecting and locating satellites and aircraft in the sky using the satellite and aircraft tracking database and the optical device sensor.

The optical correction and filtering function is the process of adjusting the optical device settings or electronically filtering out the streaks caused by satellites and aircraft from the astronomical images using the optical correction and filtering module.

The shutter and blocking control function is the process of controlling the shutter or employing a blocking device to prevent the exposure of the optical device sensor to the satellites and aircraft using the shutter and blocking device.

This diagram shows a line drawing of the optical device. The device is a telescope that captures and records astronomical images. The device has a lens, a sensor, and a shutter. The device also has a wireless transmitter and a power source. The device works as follows:

The lens is a curved glass or plastic piece that focuses the light from the astronomical objects onto the sensor. The lens can be adjusted to change the magnification and the field of view of the device.

The sensor is a device that converts the light into electrical signals that form the astronomical images. The sensor can be a charge-coupled device (CCD) or a complementary metal-oxide-semiconductor (CMOS) device. The sensor can also be adjusted to change the exposure time and the sensitivity of the device.

The shutter is a device that controls the amount of light that reaches the sensor. The shutter can be opened or closed to start or stop the exposure of the sensor. The shutter can also be adjusted to change the duration and the frequency of the exposure of the sensor.

The wireless transmitter is a device that communicates with the satellite and aircraft tracking database and the optical correction and filtering module. The transmitter sends and receives data and commands to and from the database and the module.

The power source is a device that provides the energy for the operation and function of the device. The power source can be a battery, a solar panel, or a generator.

In some embodiments, an artificial intelligence assisted physician assistant is provided. Those and the systems and devices, for example the artificial intelligence or AI system through a mobile terminal or through cloud using large language model LLM. The collect all the information of the certain patient or the medical records available to the physician while protecting the patient's privacy. Build a model for the patient and look up the most likely diagnosis for the patient and provide to the physicians and also look up through the internet or the medical literature and research literature. And based on the patient's data, including the user data and medical records and come up with the best diagnosis and also building a computer simulation model of the patient's information including a weight. Blood pressure, blood composition, blood work, genetics, genetic information, that dietary habit including the recorded user, data from the patients either daily survey or daily record and also including data. From the patients who and the patients pec, including chemical analysis, using the simulation to build a realistic whole-body modeling of the patient through the modeling not only. Probable diagnosis can be provided to the physician. Also, medical literature research can be provided, including the most likely diagnosis and the best treatment strategy. Then the physician can prescribe prescription drugs for the. Patient but before patient or prescribed the drugs, the drugs is input into the realistic simulation of the whole patient body going through all the physical and chemical processes inside the simulated physics, the patient's body including. The genetic information specific to the patients and then simulate all the possible outcome including therapeutic effect and side effects and provided to the physician and the patient for reference. Right me patiently application based on the above.

### Artificial Intelligence-Assisted Physician Assistant System

The artificial intelligence (AI)-assisted physician assistant system can enhance medical diagnosis and treatment planning. By integrating patient data, medical literature, and computer simulations, the system provides physicians with accurate diagnoses, treatment strategies, and potential outcomes. The AI system ensures patient privacy while improving healthcare decision-making.

Medical professionals face challenges in diagnosing complex cases and selecting optimal treatments. Existing solutions lack real-time integration of patient data, medical research, and personalized simulations.

### Data Collection and Privacy Protection:

The system collects patient data, including medical records and user information.

Ensures privacy compliance by anonymizing and securely storing patient data.

Accessible through mobile terminals or cloud-based platforms.

### AI Diagnosis and Literature Research:

AI model analyzes patient data to generate probable diagnoses.

Searches medical literature and research databases for relevant information.

Provides physicians with evidence-based insights.

### Computer Simulation Modeling:

Constructs a whole-body simulation model for each patient.

Includes weight, blood pressure, blood composition, genetics, dietary habits, and daily survey data.

Simulates physical and chemical processes within the patient's body.

### Treatment Strategy and Outcome Prediction:

Recommends the best treatment strategy based on diagnosis and literature.

Integrates genetic information for personalized medicine.

Simulates therapeutic effects and potential side effects.

Provides physicians and patients with outcome scenarios.

A system for assisting physicians in medical diagnosis and treatment planning, comprising:

An AI model for analyzing patient data and generating probable diagnoses.

A medical literature research component for evidence-based insights.

A computer simulation module for constructing whole-body models and predicting treatment outcomes.

Wherein patient privacy is protected through anonymization and secure data storage.

The system further comprising a user-friendly interface accessible via mobile terminals or cloud platforms.

Wherein treatment strategies consider genetic information and personalized factors.

The proposed AI-assisted physician assistant system revolutionizes healthcare by combining data-driven diagnosis, literature research, and personalized simulations. By empowering physicians with accurate information, various embodiments of the present disclosure can help improving patient outcomes and ensures privacy compliance.

This diagram shows the main components and functions of the AI-assisted physician assistant system for medical diagnosis and treatment planning. The system consists of four main components: the patient data, the medical literature, the computer simulations, and the AI system. The system performs three main functions: diagnosis, treatment, and outcome.

The patient data is the data that contains the medical history, symptoms, test results, and other relevant information of the patient. The patient data is collected and stored securely by the AI system.

The medical literature is the literature that contains the scientific research, clinical trials, guidelines, and best practices of the medical field. The medical literature is accessed and analyzed by the AI system.

The computer simulations are the simulations that model the physiological and pathological processes of the patient's body and the effects of the treatment options. The computer simulations are created and run by the AI system.

The AI system is the system that integrates the patient data, the medical literature, and the computer simulations to provide the physicians with accurate diagnoses, treatment strategies, and potential outcomes. The AI system uses natural language processing, machine learning, and deep learning techniques to perform the functions. The AI system also ensures patient privacy while improving healthcare decision-making.

The diagnosis function is the process of identifying and explaining the medical condition of the patient based on the patient data and the medical literature by the AI system.

The treatment function is the process of recommending and planning the best treatment option for the patient based on the diagnosis, the patient data, the medical literature, and the computer simulations by the AI system.

The outcome function is the process of predicting and evaluating the expected outcome of the treatment for the patient based on the treatment, the patient data, the medical literature, and the computer simulations by the AI system.

This diagram shows a line drawing of the AI system. The system is a computer device that performs the functions of the AI-assisted physician assistant system for medical diagnosis and treatment planning. The system has a processor, a memory, a storage, a network interface, and a user interface. The system works as follows:

The processor is a device that executes the instructions and algorithms of the AI system. The processor uses natural language processing, machine learning, and deep learning techniques to perform the diagnosis, treatment, and outcome functions.

The memory is a device that stores the temporary data and information of the AI system. The memory holds the patient data, the medical literature, and the computer simulations while the processor performs the functions.

The storage is a device that stores the permanent data and information of the AI system. The storage saves the patient data, the medical literature, and the computer simulations for future use and reference.

The network interface is a device that connects the AI system to the internet and other devices. The network interface enables the AI system to access and analyze the medical literature, as well as to communicate and share the results with the physicians and other systems.

The user interface is a device that provides the input and output of the AI system. The user interface allows the AI system to receive the patient data and the physician's queries, as well as to display the diagnosis, treatment, and outcome results.

Louder sound output to deter potential attackers.

### Animal Language Simulation:

Simulates dog language using meaner, dominant dog barking.

Optionally simulates other animal roars (e.g., tiger, lion, bear).

Subsonic frequencies that are sensitive to dogs' ears.

### Database of Animal Sounds:

### Method for Publishing

Conventional book publishing involves an author writing up a substantial content first, and then seeks a publisher. Conversely, a publisher may seek potential writers to have the writers write books of the publisher's interest or of the writers' expertise. A typical agent may contact a writer, or vice versa, and the agent helps the individual writer to publish books through a publisher.

In one aspect, embodiments disclosed herein relate to a method for publishing, including establishing a business entity, the business entity identifying a plurality of clients who desire to have their proposed works published, subcontracting the works to one or more writers, and publishing the works for the clients.

Various embodiments of the present disclosure provide a computer based voting system and method and apparatus. Traditionally, voting is done on paper ballots or localized voting machines and the voters are disconnected. From the outcome in this new voting system and the methods of voter voting are through the internet, a cloud server and the results are automatically linked to the individual. Users voting results. For example, if a voter votes for a certain war, the voter will automatically be entered for drafting to be recruited for the war itself if a voter vote. More certain education system, parts of the voters tax dollars are automatically added as you allocated to the voting to the education facility methods of curriculum if a voter. Votes for certain environmental measures. The voters voting result will be correlated to his tax contributions to the environmental measures. This way voters interest will be. More directly linked to the outcome, the money, and, as even their life devoted to such a voting outcome. Traditionally, the many voters vote by party lines with fixed parties. In this inventive voting system and methods, the voters do not vote for certain parties, rather the voters. What will be based on policies and the certain policies automatically group together and form certain policy based new parties. These parties are dynamic, dynamic parties. And evolve based on the society needs.

A computer-based voting system and method are disclosed, revolutionizing the traditional voting process. Unlike paper ballots or localized voting machines, this innovative system leverages the internet, cloud servers, and individualized results.

Individualized Voting: Voters cast their ballots online, securely connected to a cloud-based server. Each vote is uniquely linked to the individual voter.

### Outcome Correlation:

War Voting: If a voter supports a particular war, their vote automatically enters them into a draft pool for recruitment.

Education Funding: When a voter supports specific education policies, a portion of their tax dollars is allocated directly to the corresponding curriculum.

Environmental Measures: Voting for environmental initiatives correlates with the voter's tax contributions to environmental programs.

### Dynamic Parties:

Instead of fixed party lines, voters base their choices on policies. These policy-based parties dynamically evolve to address society's changing needs.

### Individualized Voting

Voters access the system via a secure online portal.

Each voter receives a unique computer-readable code via mail, ensuring identity confirmation.

Voters select their choices, and an electronic signature confirms their ballot information.

The system separates voter identification from votes to maintain anonymity.

Votes are stored on a distributed ledger using blockchain technology.

### Outcome Correlation

### War Voting:

If a voter supports a war, their vote triggers automatic entry into a draft pool.

This ensures that those advocating for war are directly impacted by its consequences.

### Education Funding:

Votes for education policies directly allocate tax dollars to relevant curriculum areas.

The more a voter supports education, the greater their contribution to educational programs.

### Environmental Measures:

Environmental votes correlate with the voter's tax contributions to environmental initiatives.

This aligns personal interests with funding for environmental protection.

### Dynamic Parties

Voters no longer adhere to fixed party affiliations.

Instead, they align with policy-based parties that evolve based on societal needs.

These dynamic parties adapt to changing circumstances, fostering a more responsive political landscape.

The proposed computer-based voting system and method enhance voter engagement, transparency, and accountability. By linking individual actions to outcomes, citizens become active participants in shaping their society. Various embodiments of the present disclosure can provide a significant leap toward a more informed and impactful democratic process.

Various embodiments of the present disclosure provide a computer-based system, methods and network as well as devices configured to curb gun violence. This system can automatically monitor misdemeanor violations such as simple traffic violations, then automatically enter such a vehicle user. Database into a database of prohibiting these users to have to own firearms because typical gun violences are related from. Either those who disregarded the law or rules are who are absent minded and these characters are highly correlated with the driving behaviors. So based on driving. Behaviors. The database can be created to automatically prevent certain groups of the society to own firearms. There is little legal basis to this too, because they have. Broken the law, even though traffic law in the first place. By doing so, it is projected that gun violence can be reduced by at least 50% and so is traffic. Death would also be reduced by at least 50%, saving 10s of billions of dollars of to the society. As well as thousands of lives.

In the computer-based system, methods, and network designed to curb gun violence according to various embodiments, by monitoring misdemeanor violations, particularly traffic violations, and correlating them with driving behaviors, this system aims to prevent certain individuals from owning firearms. The proposed system has the potential to significantly reduce gun violence and traffic-related deaths, resulting in substantial societal benefits.

Gun violence is a pressing issue in society, and innovative solutions are needed to address it effectively. The proposed computer-based system leverages data-driven approaches to enhance public safety and prevent firearm-related incidents.

### Monitoring Misdemeanor Violations

The system continuously monitors misdemeanor violations, with a focus on traffic-related offenses.

Violations such as reckless driving, speeding, or running red lights are automatically recorded and linked to individual users.

### Database Creation

The system maintains a centralized database of users who have committed misdemeanor violations.

These users are flagged as ineligible to own firearms based on their disregard for traffic laws.

Correlation with Driving Behaviors

Research indicates a strong correlation between certain driving behaviors and propensity for violence.

Users who exhibit absent-mindedness, impulsivity, or disregard for rules are at higher risk for gun-related incidents.

Legal Basis: while traffic violations may seem unrelated to gun ownership, they serve as an indicator of behavioral tendencies.

Existing legal frameworks allow for restricting firearm ownership based on behavioral risk factors.

### Projected Impact

By preventing certain groups from owning firearms, the system aims to reduce gun violence by at least 50%.

Simultaneously, traffic-related deaths are expected to decrease by a similar percentage.

These reductions translate to significant cost savings and thousands of lives saved.

The proposed computer-based system represents a novel approach to curbing gun violence. By leveraging existing legal mechanisms and correlating misdemeanor violations with driving behaviors, we can create a safer society for all. Various embodiments of the present disclosure can have the potential to save lives, reduce healthcare costs, and enhance public safety.

A block diagram of the computer-based system for curbing gun violence.

This diagram shows the main components and functions of the computer-based system for curbing gun violence. The system consists of four main components: the traffic monitoring device, the cloud server, the firearm database, and the firearm control device. The system performs four main functions: traffic violation detection, driving behavior analysis, firearm ownership evaluation, and firearm access restriction.

The traffic monitoring device is a device installed in the vehicle that records and transmits traffic violations, such as speeding, running red lights, or driving under the influence, to the cloud server.

The cloud server is a platform that receives and processes the traffic violation data from the traffic monitoring device. The server also performs driving behavior analysis, which is a function that uses machine learning algorithms to identify patterns and trends in the driving behavior of the vehicle owner, such as aggressiveness, recklessness, or impulsiveness.

The firearm database is a database that stores and updates the firearm ownership information of the vehicle owner, such as the type, model, serial number, and location of the firearm, as well as the license and registration status of the firearm owner.

The firearm control device is a device attached to the firearm that controls the access and operation of the firearm. The device communicates with the cloud server and receives commands to lock or unlock the firearm based on the firearm ownership evaluation.

The firearm ownership evaluation is a function that determines the eligibility and suitability of the vehicle owner to own and use a firearm. The evaluation is based on the traffic violation data, the driving behavior analysis, and the firearm ownership information. The evaluation uses a scoring system that assigns points to different factors, such as the frequency, severity, and recency of the traffic violations, the level of risk and danger of the driving behavior, and the compliance and responsibility of the firearm ownership. The evaluation also considers the legal and ethical implications of the firearm ownership, such as the background check, the mental health assessment, and the social impact of the firearm use. The evaluation generates a score that indicates the likelihood of the vehicle owner to cause or be involved in gun violence. The score is compared to a threshold value that determines the firearm access restriction.

The firearm access restriction is a function that controls the access and operation of the firearm based on the firearm ownership evaluation. The function sends commands to the firearm control device to lock or unlock the firearm. The function also sends notifications and alerts to the vehicle owner, the firearm owner, the law enforcement agencies, and the firearm dealers about the firearm access restriction status and the reasons for the restriction.

This diagram shows the main steps and logic of the computer-based method for curbing gun violence. The method consists of six main steps: traffic violation detection, driving behavior analysis, firearm ownership evaluation, firearm access restriction, notification and alert, and feedback and update.

The traffic violation detection step is the process of recording and transmitting traffic violations from the traffic monitoring device to the cloud server.

The driving behavior analysis step is the process of identifying patterns and trends in the driving behavior of the vehicle owner using machine learning algorithms on the cloud server.

The firearm ownership evaluation step is the process of determining the eligibility and suitability of the vehicle owner to own and use a firearm based on the traffic violation data, the driving behavior analysis, and the firearm ownership information on the cloud server.

The firearm access restriction step is the process of controlling the access and operation of the firearm based on the firearm ownership evaluation on the cloud server.

The notification and alert step is the process of sending notifications and alerts to the vehicle owner, the firearm owner, the law enforcement agencies, and the firearm dealers about the firearm access restriction status and the reasons for the restriction on the cloud server.

The feedback and update step is the process of receiving feedback and updating the traffic violation data, the driving behavior analysis, the firearm ownership information, and the firearm access restriction status on the cloud server.

This diagram shows a line drawing of the traffic monitoring device. The device is a small box that is installed in the vehicle, preferably in a hidden or inconspicuous location. The device has a camera, a microphone, a GPS, a wireless transmitter, and a power source. The device uses the camera and the microphone to capture and record traffic violations, such as speeding, running red lights, or driving under the influence. The device uses the GPS to track and record the location and speed of the vehicle. The device uses the wireless transmitter to send the traffic violation data to the cloud server. The device uses the power source to operate and function.

This diagram shows a line drawing of the firearm control device. The device is a small lock that is attached to the firearm, preferably in a position that prevents the trigger from being pulled. The device has a wireless receiver, a locking mechanism, and a power source. The device uses the wireless receiver to communicate with the cloud server and receive commands to lock or unlock the firearm. The device uses the locking mechanism to physically block or allow the access and operation of the firearm. The device uses the power source to operate and function.

This diagram shows the main components and functions of the computer-based system for certain behaviors. The system consists of four main components: the behavior monitoring device, the cloud server, the dangerous device database, and the dangerous device control device. The system performs four main functions: behavior detection, behavior analysis, device ownership evaluation, and device access restriction.

The behavior monitoring device is a device installed in the vehicle that records and transmits behavior data, such as speed, acceleration, braking, steering, and lane changing, to the cloud server. The device also receives commands from the cloud server to control the vehicle.

The cloud server is a platform that receives and processes the behavior data from the behavior monitoring device. The server also performs behavior analysis, which is a function that uses machine learning algorithms to identify and classify severe behaviors of the vehicle owner, such as speeding, aggressive maneuvers, tailgating, or weaving. The server also performs device ownership evaluation, which is a function that determines the eligibility and suitability of the vehicle owner to own and use a dangerous device, such as a firearm, a knife, or an explosive.

The dangerous device database is a database that stores and updates the dangerous device ownership information of the vehicle owner, such as the type, model, serial number, and location of the device, as well as the license and registration status of the device owner.

The dangerous device control device is a device attached to the dangerous device that controls the access and operation of the device. The device communicates with the cloud server and receives commands to lock or unlock the device based on the device ownership evaluation.

The behavior detection function is the process of recording and transmitting behavior data from the behavior monitoring device to the cloud server.

The behavior analysis function is the process of identifying and classifying severe behaviors of the vehicle owner using machine learning algorithms on the cloud server.

The device ownership evaluation function is the process of determining the eligibility and suitability of the vehicle owner to own and use a dangerous device based on the behavior data, the behavior analysis, and the dangerous device ownership information on the cloud server.

The device access restriction function is the process of controlling the access and operation of the dangerous device based on the device ownership evaluation on the cloud server.

This diagram shows the main steps and logic of the computer-based method for certain behaviors. The method consists of six main steps: behavior detection, behavior analysis, device ownership evaluation, device access restriction, notification and alert, and feedback and update.

The behavior detection step is the process of recording and transmitting behavior data from the behavior monitoring device to the cloud server.

The behavior analysis step is the process of identifying and classifying severe behaviors of the vehicle owner using machine learning algorithms on the cloud server.

The device ownership evaluation step is the process of determining the eligibility and suitability of the vehicle owner to own and use a dangerous device based on the behavior data, the behavior analysis, and the dangerous device ownership information on the cloud server.

The device access restriction step is the process of controlling the access and operation of the dangerous device based on the device ownership evaluation on the cloud server.

The notification and alert step is the process of sending notifications and alerts to the vehicle owner, the device owner, the law enforcement agencies, and the device dealers about the device access restriction status and the reasons for the restriction on the cloud server.

The feedback and update step is the process of receiving feedback and updating the behavior data, the behavior analysis, the device ownership information, and the device access restriction status on the cloud server.

This diagram shows a line drawing of the behavior monitoring device. The device is a small box that is installed in the vehicle, preferably in a hidden or inconspicuous location. The device has a sensor, a wireless transmitter, and a power source. The device uses the sensor to collect and record behavior data, such as speed, acceleration, braking, steering, and lane changing. The device uses the wireless transmitter to send the behavior data to the cloud server. The device also receives commands from the cloud server to control the vehicle. The device uses the power source to operate and function.

This diagram shows a line drawing of the dangerous device control device. The device is a small lock that is attached to the dangerous device, preferably in a position that prevents the operation of the device. The device has a wireless receiver, a locking mechanism, and a power source. The device uses the wireless receiver to communicate with the cloud server and receive commands to lock or unlock the device. The device uses the locking mechanism to physically block or allow the access and operation of the device. The device uses the power source to operate and function.

In some other implementations, rather than using a lock, the law enforcement can be informed and authorized to reject the individual's firearm applications, black list gun sales, or even conduct search warrants to remove the dangerous devices from the dangerous individuals.

Various embodiments of the present disclosure provide automatic systems and computer devices on a vehicle or mobile based device to automatically queue the driver or the autopilot of the vehicle to identify dangerous behaviors of other vehicles nearby, including larger vehicles such as trucks, and dangerous driving behaviors such as speeding, such as swearing among traffic, such as roads drivers who keep a much smaller. With distance compared with other drivers. Once these drivers and driving behaviors are identified, then automatically kill the driver or the Autopilot of this vehicle to keep a much larger safety distance compared with the regular distance based on the above.

### Automatic System for Enhancing Vehicle Safety and Preventing Dangerous Driving Behaviors

Various embodiments of the present disclosure relate to an automatic system and computer devices installed in vehicles or mobile-based devices. This system aims to enhance driver safety by identifying dangerous behaviors of nearby vehicles, including larger vehicles such as trucks. By monitoring driving behaviors such as speeding and aggressive maneuvers, the system automatically adjusts the vehicle's following distance to maintain a safer buffer zone. Various embodiments of the present disclosure have the potential to significantly reduce accidents and improve road safety.

Driving safety is a critical concern, especially in congested traffic or when sharing the road with larger vehicles. The proposed automatic system leverages advanced technology to mitigate risks associated with dangerous driving behaviors.

### System Components

Sensors: The system utilizes onboard sensors (such as cameras, radar, lidar) to monitor nearby vehicles.

Processing Unit: A powerful onboard computer processes sensor data in real-time.

Algorithms: Proprietary algorithms analyze driving behaviors and assess risk levels.

### Identifying Dangerous Behaviors

Speeding: The system detects vehicles exceeding speed limits or driving significantly faster than surrounding traffic.

Aggressive Maneuvers: Sudden lane changes, tailgating, and abrupt braking are flagged as risky behaviors.

Swearing Among Traffic: Audio sensors identify aggressive language or road rage incidents.

### Automatic Safety Adjustments

Following Distance: When dangerous behaviors are detected, the system automatically adjusts the vehicle's following distance.

Regular Distance: Maintains a safe distance based on traffic conditions.

Enhanced Safety Distance: Increases the buffer zone to minimize collision risks.

### Autopilot Integration

For vehicles equipped with autopilot features, the system communicates directly with the autopilot.

If the driver fails to respond to warnings or corrective prompts, the autopilot intervenes to maintain safety.

### Legal Considerations

The system operates within existing traffic laws and regulations.

It does not override driver control but enhances safety by providing real-time feedback.

The proposed automatic system represents a significant advancement in road safety technology. By identifying dangerous behaviors and adjusting following distances, it contributes to accident prevention and overall driver well-being.

A block diagram of the automatic system for enhancing vehicle safety and preventing dangerous driving behaviors.

This diagram shows the main components and functions of the automatic system for enhancing vehicle safety and preventing dangerous driving behaviors. The system consists of four main components: the vehicle device, the mobile device, the cloud server, and the vehicle control system. The system performs four main functions: driving behavior monitoring, driving behavior analysis, following distance adjustment, and vehicle control.

The vehicle device is a device installed in the vehicle that collects and transmits driving behavior data, such as speed, acceleration, braking, steering, and lane changing, to the mobile device and the cloud server. The device also receives commands from the mobile device and the cloud server to control the vehicle.

The mobile device is a device carried by the driver that communicates with the vehicle device and the cloud server. The device also provides a user interface for the driver to access and manage the system settings and preferences.

The cloud server is a platform that receives and processes the driving behavior data from the vehicle device and the mobile device. The server also performs driving behavior analysis, which is a function that uses machine learning algorithms to identify and classify dangerous driving behaviors of nearby vehicles, such as speeding, aggressive maneuvers, tailgating, or weaving. The server also performs following distance adjustment, which is a function that calculates and recommends the optimal following distance for the vehicle based on the driving behavior analysis and the road conditions.

The vehicle control system is a system that controls the vehicle's speed, braking, and steering based on the commands from the vehicle device and the cloud server. The system also provides feedback and alerts to the driver about the vehicle's status and performance.

The driving behavior monitoring function is the process of collecting and transmitting driving behavior data from the vehicle device to the mobile device and the cloud server.

The driving behavior analysis function is the process of identifying and classifying dangerous driving behaviors of nearby vehicles using machine learning algorithms on the cloud server.

The following distance adjustment function is the process of calculating and recommending the optimal following distance for the vehicle based on the driving behavior analysis and the road conditions on the cloud server.

The vehicle control function is the process of controlling the vehicle's speed, braking, and steering based on the commands from the vehicle device and the cloud server.

Flow chart of the automatic method for enhancing vehicle safety and preventing dangerous driving behaviors.

This diagram shows the main steps and logic of the automatic method for enhancing vehicle safety and preventing dangerous driving behaviors. The method consists of six main steps: driving behavior monitoring, driving behavior analysis, following distance adjustment, vehicle control, feedback and alert, and user interface.

The driving behavior monitoring step is the process of collecting and transmitting driving behavior data from the vehicle device to the mobile device and the cloud server.

The driving behavior analysis step is the process of identifying and classifying dangerous driving behaviors of nearby vehicles using machine learning algorithms on the cloud server.

The following distance adjustment step is the process of calculating and recommending the optimal following distance for the vehicle based on the driving behavior analysis and the road conditions on the cloud server.

The vehicle control step is the process of controlling the vehicle's speed, braking, and steering based on the commands from the vehicle device and the cloud server.

The feedback and alert step is the process of providing feedback and alerts to the driver about the vehicle's status and performance from the vehicle control system.

The user interface step is the process of accessing and managing the system settings and preferences from the mobile device.

This diagram shows a line drawing of the vehicle device. The device is a small box that is installed in the vehicle, preferably in a hidden or inconspicuous location. The device has a sensor, a wireless transmitter, and a power source. The device uses the sensor to collect and record driving behavior data, such as speed, acceleration, braking, steering, and lane changing. The device uses the wireless transmitter to send the driving behavior data to the mobile device and the cloud server. The device also receives commands from the mobile device and the cloud server to control the vehicle. The device uses the power source to operate and function.

This diagram shows a line drawing of the mobile device. The device is a smartphone or a tablet that is carried by the driver. The device has a wireless receiver, a touch screen, and a power source. The device uses the wireless receiver to communicate with the vehicle device and the cloud server. The device also provides a user interface for the driver to access and manage the system settings and preferences. The device uses the touch screen to display and input information. The device uses the power source to operate and function.

For the convenience of description, the components of the apparatus may be divided into various modules or units according to functions which may be separately described. Certainly, when various embodiments of the present disclosure are carried out, the functions of these modules or units can be achieved utilizing one or more equivalent units of hardware or software as will be recognized by those having skill in the art.

The various device components, units, blocks, or portions may have modular configurations, or are composed of discrete components, but nonetheless can be referred to as “modules” in general. In other words, the “components,” “modules” or “units” referred to herein may or may not be in modular forms.

Persons skilled in the art should understand that the embodiments of the present disclosure can be provided for a method, system, or computer program product. Thus, various embodiments of the present disclosure can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

Various embodiments of the present disclosure are described with reference to the flow diagrams and/or block diagrams of the method, apparatus (system), and computer program product of the embodiments of the present disclosure. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory, such as a non-transitory computer-readable storage medium. The instructions can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

Processors suitable for the execution of a computer program such as the instructions described above include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

The processor or processing circuit can be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, general processors, or other electronic components, so as to perform the above image capturing method.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In some implementations, the model can reside on local processing circuits and storage devices, and the training of the model can also be performed locally. In some implementations, the model and the training can be remotely or distributed, such as in a cloud.

Data, such as the inputs, the outputs, and model predictions, can be presented to users/operators on display screens, such as organic light-emitting diode (OLED) displays screens and liquid-crystal display (LCD) screens located on a manufacturing line and/or in a control room.

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

It should be understood that each part of the present disclosure can be implemented by hardware, software, firmware, or a combination thereof. In the above embodiments, multiple steps or methods can be implemented by software or firmware stored in a memory and executed by a suitable instruction execution system. For example, if implemented in hardware, as in another embodiment, it can be implemented using any one or a combination of the following techniques known in the art: Discrete logic circuits, ASICs with suitable combinational logic gate circuits, programmable gate arrays (PGA), field programmable gate arrays (FPGA), etc.

It is apparent that those of ordinary skill in the art can make various modifications and variations to the embodiments of the disclosure without departing from the spirit and scope of the disclosure. Thus, it is intended that the present disclosure covers the modifications and variations.

Various embodiments in this specification have been described in a progressive manner, where descriptions of some embodiments focus on the differences from other embodiments, and same or similar parts among the different embodiments are sometimes described together in only one embodiment.

In addition, in the description of the present disclosure, the terms “center,” “longitudinal,” “lateral,” “length,” “width,” “thickness,” “upper,” “lower,” “front,” “rear,” “left,” “right,” “vertical,” “horizontal,” “top,” “bottom,” “inside,” “outside,” “clockwise,” “counterclockwise,” “axial,” “radial,” “circumferential,” etc. are based on the azimuth or position relationship shown in the drawings, and are only for the convenience of describing the present disclosure and simplifying the description. The orientation and construction and operation in a specific orientation cannot be understood as a limitation on the present disclosure.

In addition, the terms “first” and “second” are used for descriptive purposes only and cannot be understood as indicating or implying relative importance or implicitly indicating the number of technical features indicated. Therefore, the features defined as “first” and “second” can explicitly or implicitly include at least one of the features. In the description of the present disclosure, the meaning of “a plurality” is at least two, for example, two, three, etc., unless it is specifically and specifically defined otherwise.

Moreover, the terms “include,” “including,” or any other variations thereof are intended to cover a non-exclusive inclusion within a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, or the device including the element.

Specific examples are used herein to describe the principles and implementations of some embodiments. The description is only used to help convey understanding of the possible methods and concepts. Meanwhile, those of ordinary skill in the art can change the specific manners of implementation and application thereof without departing from the spirit of the disclosure. The contents of this specification therefore should not be construed as limiting the disclosure.

In the descriptions, with respect to circuit(s), unit(s), device(s), component(s), etc., in some occurrences singular forms are used, and in some other occurrences plural forms are used in the descriptions of various embodiments. It should be noted; however, the single or plural forms are not limiting but rather are for illustrative purposes. Unless it is expressly stated that a single unit, device, or component etc. is employed, or it is expressly stated that a plurality of units, devices or components, etc. are employed, the circuit(s), unit(s), device(s), component(s), etc. can be singular, or plural.

Based on various embodiments of the present disclosure, the disclosed apparatuses, devices, and methods can be implemented in other manners. For example, the abovementioned devices can employ various methods of use or implementation as disclosed herein.

Dividing the device into different “regions,” “units,” or “layers,” etc. merely reflect various logical functions according to some embodiments, and actual implementations can have other divisions of “regions,” “units,” or “layers,” etc. realizing similar functions as described above, or without divisions. For example, multiple regions, units, or layers, etc. can be combined or can be integrated into another system. In addition, some features can be omitted, and some steps in the methods can be skipped.

Those of ordinary skill in the art will appreciate that the units, regions, or layers, etc. in the devices provided by various embodiments described above can be provided in the one or more devices described above. They can also be located in one or multiple devices that is (are) different from the example embodiments described above or illustrated in the accompanying drawings. For example, the units, regions, or layers, etc. in various embodiments described above can be integrated into one module or divided into several sub-modules.

The order of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

In the present disclosure, the terms “installation,” “connected,” “connected,” “fixed” and other terms shall be understood in a broad sense unless otherwise specified and limited, for example, they can be fixed connections or removable connections or integrated; it can be mechanical or electrical; it can be directly connected or indirectly connected through an intermediate medium; it can be the internal connection of two elements or the interaction between two elements, unless otherwise specified. For those of ordinary skill in the art, the specific meanings of the above terms in the present disclosure can be understood according to specific situations.

In the present disclosure, unless explicitly stated and defined otherwise, the first feature being “on” or “over” the second feature may be the first and second features in direct contact, or the first and second features indirectly contact through an intermediate medium. Moreover, the first feature being “above” the second feature may indicate that the first feature is directly above or obliquely above the second feature, or it only indicates that the first feature is higher in level than the second feature. The first feature being “below,” “under,” or “underneath” the second feature indicates that the first feature may be directly below or obliquely below the second feature, or it may simply indicate that the first feature is less horizontal than the second feature.

In the description of this specification, the description with reference to the terms “one embodiment,” “some embodiments,” “examples,” “specific examples,” or “some examples” and the like means specific features described in conjunction with the embodiments or examples. Structures, materials, or features are included in at least one embodiment or example of the disclosure. In this specification, the schematic expressions of the above terms are not necessarily directed to the same embodiment or example. Furthermore, the particular features, structures, materials, or characteristics described can be combined in any suitable manner in any one or more embodiments or examples. In addition, without any contradiction, those skilled in the art can combine and combine different embodiments or examples and features of the different embodiments or examples described in this specification.

Various modifications of, and equivalent acts corresponding to the disclosed aspects of the exemplary embodiments can be made in addition to those described above by a person of ordinary skill in the art having the benefit of the present disclosure without departing from the spirit and scope of the disclosure contemplated by this disclosure and as defined in the following claims. As such, the scope of this disclosure is to be accorded the broadest reasonable interpretation so as to encompass such modifications and equivalent structures.

All references cited in the present disclosure are incorporated by reference in their entirety.

For the convenience of description, the components of the apparatus may be divided into various modules or units according to functions which may be separately described. Certainly, when various embodiments of the present disclosure are carried out, the functions of these modules or units can be achieved utilizing one or more equivalent units of hardware or software as will be recognized by those having skill in the art.

The various device components, units, blocks, or portions may have modular configurations, or are composed of discrete components, but nonetheless can be referred to as “modules” in general. In other words, the “components,” “modules” or “units” referred to herein may or may not be in modular forms.

Persons skilled in the art should understand that the embodiments of the present disclosure can be provided for a method, system, or computer program product. Thus, various embodiments of the present disclosure can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

Various embodiments of the present disclosure are described with reference to the flow diagrams and/or block diagrams of the method, apparatus (system), and computer program product of the embodiments of the present disclosure. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory, such as a non-transitory computer-readable storage medium. The instructions can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

For example, the motion-sickness methods and devices described above can be implemented as software applications (Apps), disseminated through various App stores, and users can download such Apps onto their mobile phones or tablet computers, and use such Apps while being passengers in an aircraft or vehicle, while following the visual or audio cues provided by the Apps on their displays to turn/rotate/control the device to turn left, right, up, down, etc., as if they are in control of the aircraft/vehicle as pilots/drivers themselves, thereby reducing motion sickness.

The operations described in this disclosure can be implemented as operations performed by a data processing apparatus on data stored on one or more computer-readable storage devices or received from other sources.

Processors suitable for the execution of a computer program such as the instructions described above include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

The processor or processing circuit can be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, general processors, or other electronic components, so as to perform the above image capturing method.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In some implementations, the model can reside on local processing circuits and storage devices, and the training of the model can also be performed locally. In some implementations, the model and the training can be remotely or distributed, such as in a cloud.

Data, such as the inputs, the outputs, and model predictions, can be presented to users/operators on display screens, such as organic light-emitting diode (OLED) displays screens and liquid-crystal display (LCD) screens located on a manufacturing line and/or in a control room.

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation to encompass such modifications and equivalent structures.

What is claimed is:

1. A method for presentation of content in a digital document, comprising:
automatically altering the presentation based on spatiotemporal parameters of the content inputted by one or more users.

2. The method of claim 1, wherein the digital document is a spread sheet or a word processing document.

3. The method of claim 2, wherein the presentation is a visual presentation.

4. The method of claim 3, wherein the visual presentation comprises at least one of colors, shades, or fonts.

5. The method of claim 4, wherein the spatiotemporal parameters comprise a time of input of the content.

6. The method of claim 5, wherein the colors gradually change over time elapsed since the time of input of the content.

7. The method of claim 6, wherein the colors change from red to orange, to green, and then to black over the time elapsed.

8. The method of claim 5, wherein the fonts are normal and upright at the time of input of the content.

9. The method of claim 8, wherein the fonts are automatically rotated sideways over the time elapsed as if falling asleep.

10. The method of claim 5, wherein the shades gradually fade over time elapsed since the time of input of the content.

11. The method of claim 10, wherein the shades gradually become lighter over the time elapsed.

12. The method of claim 2, wherein the presentation is an audio presentation.

13. The method of claim 12, wherein the audio presentation turns into a sleepy tone over the elapsed time.

14. The method of claim 2, wherein the presentation comprises texts, wherein the texts are presented in an initial font style and color selected by a user or by system default at the time of input, and wherein the texts gradually change in fonts and become more slanted, and gradually fade in colors and/or hues with the time elapsed to indicate an age of the content.

15. The method of claim 5, wherein the spatiotemporal parameters comprise a location and/or a user identification.

16. The method of claim 15, wherein the digital document is a collaborative document, wherein the presentation comprises texts, and wherein the texts are presented in fonts and colors automatically determined based on the location and/or the user identification to thereby differentiate inputs from different users and/or locations.

17. The method of claim 16, wherein the fonts and colors further gradually change to indicate an age of the content.

18. The method of claim 2, further comprising waking up the content by a clicking or audio command.

19. The method of claim 18, wherein said waking up comprises restoring the presentation toward the initial presentation.

20. A simulation-based optimization method, comprising:
simulating a process for drafting a patent application, including:
searching uncopyrighted literature for references related to an invention disclosure or a draft claim;
rewriting content from the references to be embodiments or variations of the invention disclosure or the draft claim;
iterating said searching the uncopyrighted literature and said rewriting the content to expand the rewritten content;
generating a plurality of draft patent applications based on the rewritten content from a plurality of subsets of the references;
selecting an optimal one of the plurality of draft patent applications to be the patent application based on at least one of a patent examination simulation or a patent litigation simulation;
wherein the patent examination simulation comprises:
searching prior art related to the plurality of draft patent applications; and
selecting one or more of the draft patent applications based on simulated allowance probabilities based on the searched prior art; and
wherein the patent litigation simulation comprises:
searching case laws related to the one or more of the plurality of draft patent applications;
searching product related to the one or more of the plurality of draft patent applications;
simulating infringement probabilities based on the searched product;
simulating invalidity proceedings and infringement findings in a number of court systems; and
selecting an optimized patent application based on likelihood of winning the invalidity proceedings and infringement findings.
